(19) United States
(12) Patent Application Publication
(10) Pub. No.: US 2012/0102201 A1
(43) Pub. Date: Apr. 26, 2012

(54) STORAGE APPARATUS AND MANAGEMENT METHOD THEREOF

(75) Inventors: Hirotaka Nakagawa, Sagamihara (JP); Mioko Mori, Yokohama (JP)

(73) Assignee: HITACHI, LTD., Tokyo (JP)

(21) Appl. No.: 12/991,976

(22) PCT Filed: Oct. 25, 2010
(86) PCT No.: PCT/JP2010/006306

§ 371 Date: Nov. 10, 2010

(51) Int. Cl. G06F 15/173

(52) U.S. Cl. 709/226

(57) ABSTRACT

As a result of operating interference between managing users using the storage apparatus, management tasks on the storage apparatus are delayed and there is the risk of host tasks being delayed or stopped.

With a storage apparatus which is managed by a plurality of managing users and a control method thereof, management target resources are divided into a plurality of resource groups; and, by executing exclusive control processing which places the resource groups into an exclusive control range for management operations by the managing users, the scope of the exclusive control can be configured in just proportion and convenience and user friendliness can be improved.

### TECHNICAL FIELD

The present invention relates to a storage apparatus and a management method thereof and is suitably applied to a storage apparatus for which a multitenancy-type management system is adopted, for example.

### BACKGROUND ART

In recent years, in a large-scale storage aggregation environment in which a single storage apparatus is used shared between a plurality of companies or a plurality of divisions, in order to reduce the burden on storage apparatus system administrators, the demand has grown, as a storage apparatus management method, for a multitenancy-type management method with which system administrators are established in each of the companies or divisions and storage apparatuses are managed by the plurality of established system administrators.

As a multitenancy-type storage apparatus management method, conventionally a method whereby a plurality of virtual storage apparatuses are constructed by dividing resources in the storage apparatus into a plurality of logical groups in host task units and whereby the management of each of the virtual storage apparatuses is entrusted to assigned system administrators has been proposed (see PTL 1 and PTL 2, for example).

### CITATION LIST

### Patent Literature

PTL 1: Patent Publication Laid-Open No. 2006-260284
PTL 2: Patent Publication Laid-Open No. 2006-343907

### SUMMARY OF INVENTION

### Technical Problem

However, with the storage apparatus management method disclosed in this PTL 1 and PTL 2, since the individual virtual storage apparatuses are exclusive control units, if one virtual storage apparatus is managed by a plurality of managing users, while a single system administrator is performing a management operation on the virtual storage apparatus, the other system administrators do not perform a management operation on the virtual storage apparatus. As a result, the management tasks of the whole virtual storage apparatus are delayed and, worst case, there is the risk of host tasks being delayed or stopped.

Therefore, in a storage apparatus for which a multitenancy-type management system is adopted, the scope of the exclusive control can be designated in just proportion and the operating interference between system administrators can be reduced, and if the parallel processing of the management operation can be performed, the convenience and user friendliness of the storage apparatus can be improved.

The present invention was conceived in view of the above problems and proposes a storage apparatus and management method with which convenience and user friendliness can be improved.

### Solution to Problem

In order to solve this problem, the present invention provides a storage apparatus which is managed by a plurality of managing users, comprising a resource group control unit which divides management target resources into resource groups; a managing user access control unit for limiting the operational range of the managing users to resources within an assigned resource group; and an exclusive control unit which executes exclusive control processing which places the resource groups into an exclusive control range for management operations by the managing users.

Furthermore, the present invention provides a control method for the storage apparatus managed by the plurality of managing users, comprising a first step of dividing management target resources into a plurality of resource groups; a second step of executing managing user access control processing for assigning the resource group to the managing users and defining the operational range; and a third step of executing exclusive control processing which places the resource groups into an exclusive control range for management operations by the managing users.

### Advantageous Effects of Invention

According to this invention, since the access range can be configured to be in just proportion and the range of exclusive control is limited to a range that is operable by the managing users, the parallel processing of management operations on each resource can be enabled while reducing operating interference between managing users. The convenience and user-friendliness of the storage apparatus can thus be gradually improved.

### BRIEF DESCRIPTION OF DRAWINGS

FIG. 1 is a block diagram showing the whole configuration of a computer system according to first and second embodiments.

FIG. 2 is a block diagram showing a schematic configuration of a host computer.

FIG. 3 is a block diagram showing a schematic configuration of a storage apparatus.

FIG. 4 is a block diagram showing a schematic configuration of a management terminal.

FIG. 5 is a schematic diagram serving to explain a system for controlling managing user access of the storage apparatus according to this embodiment.

FIG. 6 is a schematic diagram serving to explain a system for controlling managing user access of the storage apparatus according to this embodiment.

FIG. 7 is a diagram serving to explain a system for controlling managing user access of the storage apparatus according to this embodiment.

FIG. 8 is a conceptual view serving to explain various programs and various tables which are stored in the control information memory of the storage apparatus.

FIG. 9 is a conceptual view conceptually illustrating the configuration of a resource group ID management table according to the first embodiment.

FIG. 10 is a conceptual view which conceptually illustrates the configuration of the resource group configuration management table.

FIG. 11 is a conceptual view which conceptually illustrates the configuration of the session management table.

FIG. 12 is a conceptual view which conceptually illustrates the configuration of a privilege bitmap management table.

FIG. 13 is a conceptual view which conceptually illustrates the configuration of a role management table.

FIG. 14 is a conceptual view which conceptually illustrates the configuration of a user group management table.

FIG. 15 is a conceptual view which conceptually illustrates the configuration of a user account management table.

FIG. 16 is a conceptual view which conceptually illustrates the configuration of a default resource group ID management table.

FIG. 17 is a conceptual view which conceptually illustrates the configuration of a program product management table.

FIG. 18 is a flowchart illustrating a processing routine for default resource group creation processing.

FIG. 19 is a flowchart illustrating a processing routine for user group creation processing according to the first embodiment.

FIG. 20A is a flowchart illustrating a processing routine for login processing.

FIG. 20B is a flowchart illustrating a processing routine for login processing.

FIG. 21A is a flowchart showing the flow of request reception processing.

FIG. 21B is a flowchart showing the flow of request reception processing.

FIG. 21C is a flowchart showing the flow of request reception processing.

FIG. 22 is a conceptual view serving to provide an overview of the second embodiment.

FIG. 23 is a conceptual view conceptually illustrating the configuration of a resource group ID management table according to the second embodiment.

FIG. 24 is a flowchart illustrating a processing routine for resource group creation processing.

FIG. 25 is a flowchart illustrating a processing routine for resource migration processing.

FIG. 26 is a flowchart illustrating a processing routine for user group creation processing according to the second embodiment.

### DESCRIPTION OF EMBODIMENTS

An embodiment of the present invention will be described in detail hereinbelow with reference to the drawings.

### (1) First Embodiment

(1-1) Configuration of a Computer System According to this Embodiment

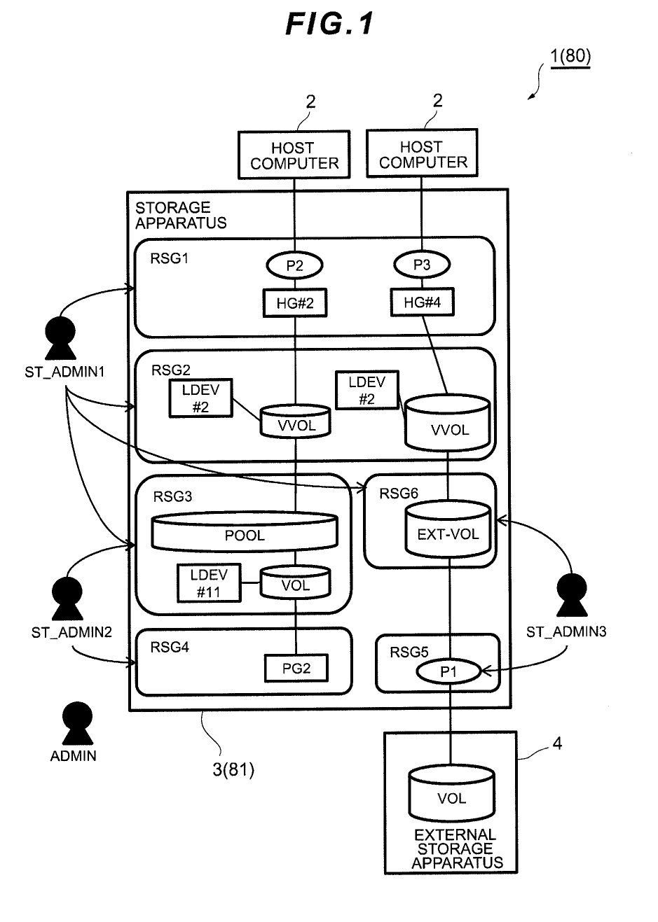

In FIG. 1, 1 denotes the whole computer system according to this embodiment. The computer system 1 is configured comprising one or more host computers 2, and a storage apparatus 3.

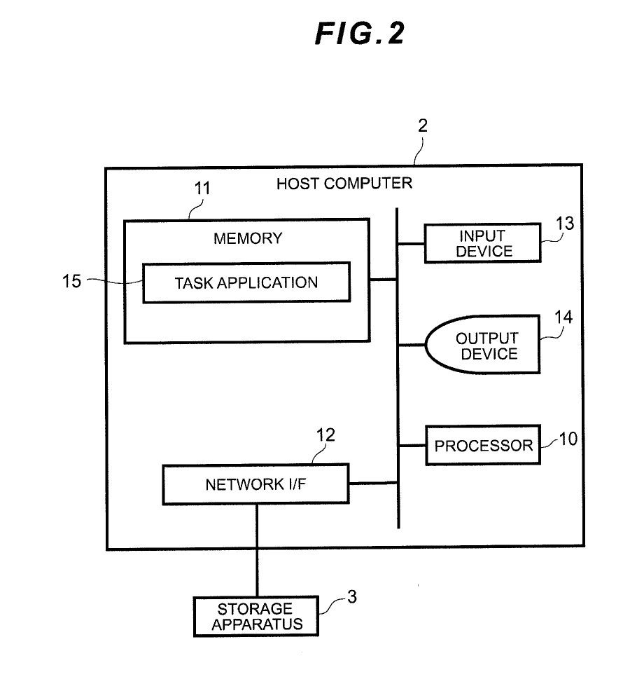

As shown in FIG. 2, the host computer 2 is a computer device which comprises a processor 10, a memory 11, a network interface 12, an input device 13, and an output device 14 and so on, and is configured from a personal computer, a workstation, a mainframe or the like, for example.

The processor 10 comprises a function for governing operational control of the whole host computer 2, and executes various control processing by executing programs which are stored in the memory 11. The memory 11 is also used as a working memory of the processor 10 in addition to being used to store programs. The application corresponding to the user task (task application) 15 is stored and saved in the memory 11.

The network interface 12 performs protocol control when communicating with the storage device 3. Data and commands are sent and received according to the Fibre Channel Protocol between the host computer 2 and storage apparatus 3 by means of the protocol control function of the network interface 12.

The input device 13 is configured from a keyboard, switch, pointing device, or microphone, for example, and the output device 14 is configured from a monitor display or speaker, or the like, for example.

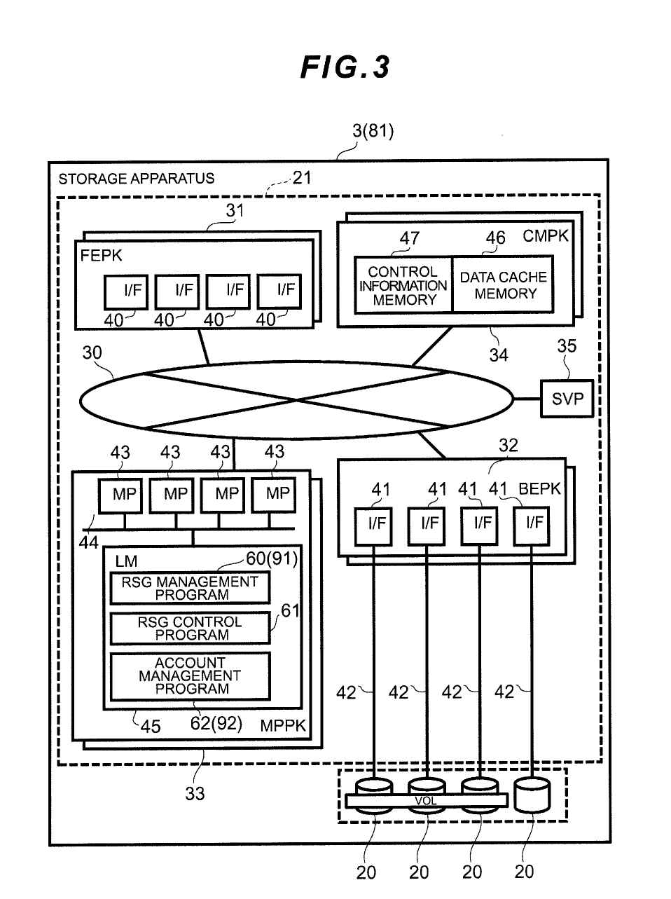

However, as shown in FIG. 3, the storage apparatus 3 is configured comprising a plurality of storage devices 20, and a controller 21 for controlling data I/Os to and from the storage devices 20.

The storage devices 20 are configured from high-cost disks such as SCSI (Small Computer System Interface) disks or low-cost disks such as SATA (Serial AT Attachment) disks or optical disks, for example. A single parity group is configured from one or more storage devices 20 and one or more logical volumes VOL (FIG. 1) are defined in the storage areas provided by the one or more parity groups. The data from the host computer 2 is then stored in the logical volumes VOL by taking blocks or files of a predetermined size as units. Note that the logical volumes VOL are each managed by assigning unique logical device numbers (LDEV#2 and LDEV#11 in FIG. 1).

The controller 21 is configured comprising one or more frontend packages 31, one or more backend packages 32, one or more microprocessor packages 33, one or more cache memory packages 34, and a management terminal 35 which are mutually connected via an internal network 30.

The frontend packages 31 comprise a plurality of host interfaces 40. These host interfaces 40 function as interfaces during communication with the host computers 2 and each comprise one or more ports (not shown). The ports are each assigned a unique address such as an IP (Internet Protocol) address or WWN (World Wide Name) address.

The backend packages 32 comprise a plurality of disk interfaces 41. These disk interfaces 41 function as interfaces during communication with the storage devices 20 and are each electrically and physically connected to the corresponding storage devices 20 via a communication cable 42 such as a Fibre Channel cable.

The microprocessor packages 33 comprise a plurality of microprocessors 43 and a local memory 45 which is connected via a bus 44 to the microprocessors 43. The microprocessors 43 comprise functions governing operational control of the whole storage apparatus 3 and read and write data from and to the corresponding storage devices 20 via the corresponding disk interface 41 of the backend package 32 in response to read request or write requests from the host computers 2 which are supplied via the host interfaces 40 of the frontend packages 31, based on the microprograms stored in the local memory 45. The local memory 45 stores, in addition to these microprograms, a portion of the control information stored in the control information memory 47 of the cache memory packages 34 (described subsequently).

The cache memory packages 34 comprises a data cache memory (hereinafter called the data cache memory) 46 and a control information memory (hereinafter called the control information memory) 47 which are configured from one or more semiconductor storage devices (for example DRAM (Dynamic Random Access Memory)). The data cache memory 46 temporarily stores data which is read to or written from the storage devices 20 and the control information memory 47 stores control information which is required for various processing, such as configuration information, on the storage devices 20.

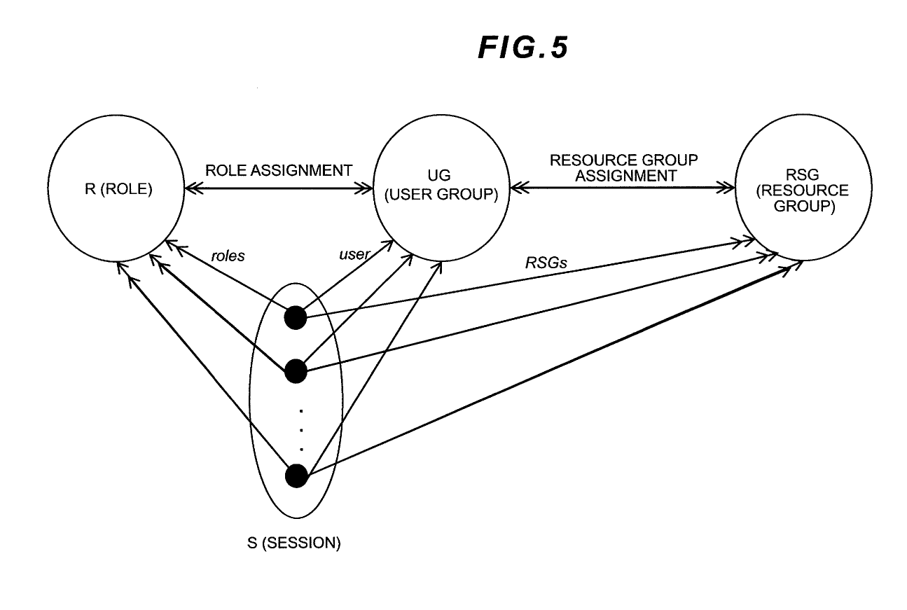

As shown in FIG. 5, the management terminal 35 is a computer device which comprises a processor 50, a memory 51, a network interface 52, an input device 53, and an output device 54 and so on, and is built into the case of the storage apparatus 3. As will be described subsequently, in cases where the configuration and so on of the storage apparatus 3 is modified, managing users connect a communication terminal device of their own (not shown) to the management terminal 35 and log in to the storage apparatus 3 via the management terminal 35.

The processor 50 comprises a function for governing operational control of the whole management terminal 35, and executes various control processing by executing programs which are stored in the memory 51. The memory 51 is also used as a working memory of the processor 50 in addition to being used to store programs. Various control processing (as will be described subsequently) is executed as a result of the processor 50 executing various programs which are stored in the memory 51. A server program 55 and a session management table 56 which will be described subsequently are stored and retained in the memory 51.

The network interface 52 performs protocol control during communications between the processor 50 and the microprocessors 43 (FIG. 3) of the microprocessor package 33 (FIG. 3) which is performed via the internal network 30 (FIG. 3). Furthermore, the input device 53 is configured from a keyboard, switch, pointing device, or microphone, for example, and the output device 54 is configured from a monitor display or speaker, or the like, for example.

Note that, in this embodiment, the storage apparatus 3 contains a volume virtualization function and an external connection function.

As shown in FIG. 1, the volume virtualization function provides the host computer 2 with a virtual volume VOL (hereinafter called the virtual volume VVOL), and is a function which dynamically assigns physical storage area to the virtual volume VVOL according to the usage status of the virtual volume VVOL.

Furthermore, the storage apparatus 3 manages one or more pre-defined volumes VOL as a single pool volume POOL, and in cases where there is a write request from the host computer 2 to a virtual storage area, in the virtual volume VVOL, to which the physical storage area has not yet been assigned, the physical storage area is assigned to the virtual storage area for which the write request in the virtual volume VVOL was provided, in predetermined units from the pool volume POOL which is associated with the virtual volume VVOL. Thus, data reading and writing from and to this virtual storage area in the virtual volume VVOL are subsequently performed in the physical storage area.

Furthermore, the external connection function is a function for providing the host computer 2 with volumes VOL in an external storage apparatus 4 (FIG. 1) which is connected to a predetermined host interface 40 in the frontend package 31 as if these volumes VOL were volumes VOL in the storage apparatus 3 itself.

In reality, the storage apparatus 3 manages a volume VOL in an external storage apparatus 4 as an external volume EXT-VOL and provides the virtual volume VVOL associated with the external volume EXT-VOL to the host computer 2.

Furthermore, when a read request or write request targeting this virtual volume VVOL is received is supplied from the host computer, the microprocessors 43 generates a read request or write request in which the read destination of the read request or write destination of the write request is overwritten with an address in the external volume EXT-VOL (more precisely, the corresponding volume VOL in this external storage apparatus 4), and transmits the generated read request or write request to the external storage apparatus 4. In addition, upon receiving a response (response command or read data) to the read request or write request from the external storage apparatus 4, the storage apparatus 3 transfers this response to the corresponding host computer 2.

(1-2) Access Control System for Storage Apparatus

An access control system for the storage apparatus 3 will be explained next.

As shown in FIG. 1, the storage apparatus 3 contains, among the resources in the storage apparatus 3, a resource group function for managing management target resources divided into one or more logical groups (hereinafter called resource groups) RSG (RSG1, RSG2, . . . ), and an exclusive control function which places each of the resource groups RSG created by this resource group function into a range of exclusive control of access by the managing users.

Furthermore, on the premise of a multitenancy-type management method, the storage apparatus 3 adopts an RBAC (Role-Based Access Control) system as the managing user access control system.

In reality, as shown in FIG. 5, in this storage apparatus 3, managing users are grouped into a plurality of groups (hereinafter called user groups UG) and to each of these user groups UG are assigned one or more operating privileges (hereinafter called roles) and one or more resource groups RSG. Furthermore, the managing users are able to perform management, within the scope of the roles assigned to the user groups UG, on the resources in the resource groups RSG assigned to the user groups UG to which the managing users belong. Note that, in FIG. 5, ‘S’ denotes a login session, and the black circles in the ellipse denoted by ‘S’ each indicate the managing users who are logged on.

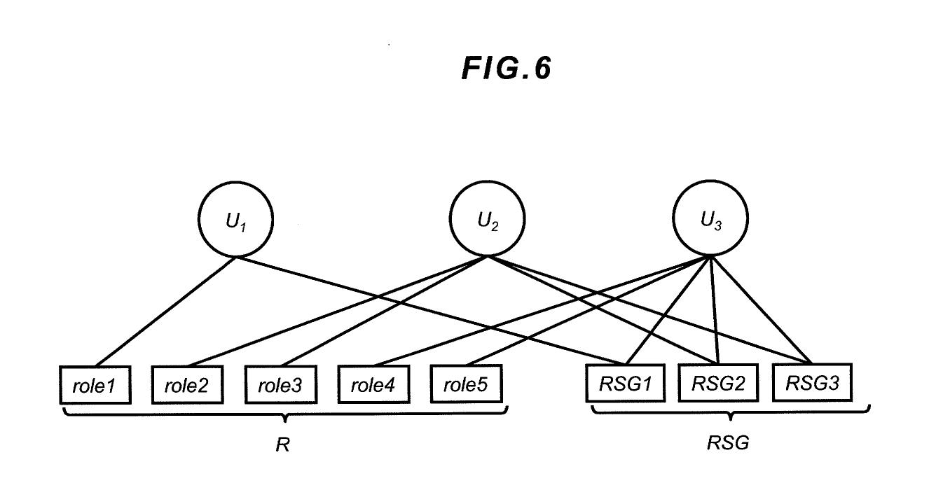

Meanwhile, FIG. 6 shows an example of assignment of roles and resource groups RSG to the user groups UG. In the case of the example in FIG. 6, a single role called ‘role1’ and a single resource group RSG known as ‘RSG1’ are assigned respectively to a user group UG called ‘U₁,’ and two roles called ‘role2’ and ‘role3’ and two resource groups RSG called ‘RSG2’ and ‘RSG3’ are assigned respectively to a user group UG called ‘U₂.’ Furthermore, two roles called ‘role4’ and ‘role5’ and a single resource group RSG called ‘RSG3’ are respectively assigned to the user group UG called ‘U₃.’ Here, if a certain user group UG wishes to occupy a resource in the storage apparatus, a resource group including the relevant resource only needs to be assigned to the occupying user group UG, and if a resource in the storage apparatus is to be shared between different user groups UG, a resource group including the relevant resource should be assigned to each of the different user groups UG.

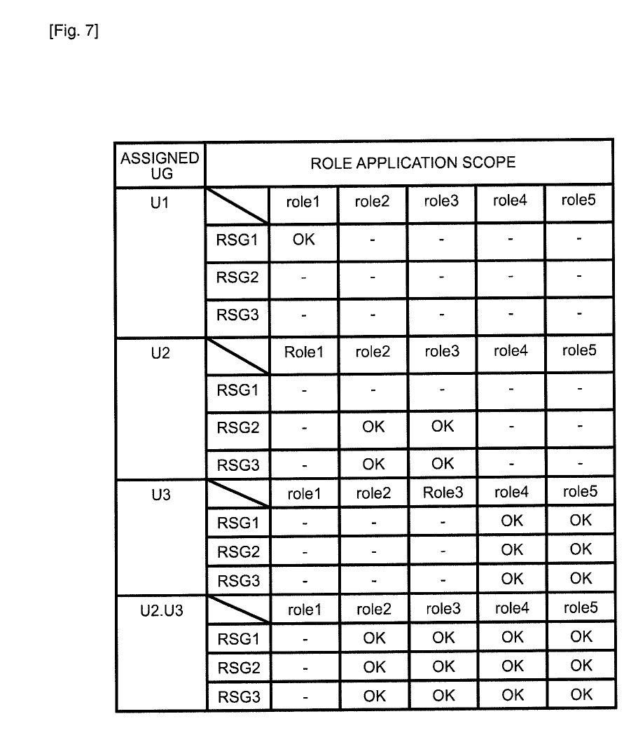

FIG. 7 shows the relationships between the user groups UG of the example in FIG. 6 and the scope of the privileges of the managing users belonging to the user groups UG (the resource groups RSG to which the roles can be applied). As can also be seen from FIG. 7, the managing users belonging to the user group UG known as ‘U₁’ each include the role known as ‘role l’ for each resource belonging to the resource group RSG known as ‘RSG1’ which is assigned to the user group UG and the users belonging to the user group UG known as ‘U₂’ each include the roles known as ‘role2’ and ‘role3’ for each resource belonging to the resource group RSG known as ‘RSG2’ and each resource belonging to the resource group known as ‘RSG3.’ In addition, each managing user belonging to the user group UG known as ‘U₃’ comprises the roles known as ‘role4’ and ‘role5’ for each resource belonging to the resource group RSG called ‘RSG3.’

Here, it is noteworthy that the users can belong to a plurality of user groups UG and if a managing user belongs to a plurality of user groups UG, the roles adopted by the managing user include all the roles assigned to the individual user groups UG for all the resource groups RSG assigned to the individual user groups UG.

For example, managing users belonging to two user groups UG called ‘U₂’ and ‘U₃’ also include, not only roles called ‘role2’ and ‘role3’ for resources belonging to the resource groups RSG known as ‘RSG2’ or ‘RSG3’, and roles called ‘role4’ and ‘role5’ for resources belonging to the resource groups RSG known as ‘RSG1’, ‘RSG2’, or ‘RSG3’, but also roles known as the ‘role2’ and ‘role3’ for resources belonging to the resource group RSG known as ‘RSG1’.

Note that the storage apparatus 3 comprises a wide variety of logical/physical elements and if a target is assumed where these elements are divided between all the resource groups RSG, there is an enormous amount of management information. The larger the number of types and quantities of the resources targeted for grouping, the greater the load on the managing user performing resource grouping, and hence the higher the overall management costs.

Therefore, as the management target resources of the resource group function, resources fulfilling the following conditions are targeted in this embodiment:

a) Resources which the managing users are aware of and are managing, and which are considered general resources regardless of the type of the storage apparatus 3 are targeted, and resources which are used in the control processing of the storage apparatus 3 are not included as targets.

b) Resources which are incorporated by the designation of other resources, such as pools and logical device groups, for example.

c) In addition to the resources from which the storage apparatus 3 is configured, such as the ports and volumes, there are cases where the ‘IDs themselves are reserved in advance’ and desired for use, and these are also included as targets.

Note that the data cache memory 46 and microprocessor 43 are resources for which there is no management to entrust to the assigned managing users, and hence these resources are not included as targets for inclusion in these resource groups RSG.

Based on the foregoing, the resources which are grouping targets in this embodiment fall into five categories, namely, logic device numbers ('LDEV#2′ and ‘LDEV#11’ in FIG. 1), a parity group ('PG2′ in FIG. 1), an external volume (‘EXT-VOL’ in FIG. 1), ports (‘P1’ to ‘P3’ in FIG. 1), and host groups (‘HG#2’ and ‘HG#4’ in FIG. 1). Here, ‘host groups’ denotes WWN and IP address groups of each of the host computers 2 which access ports of the storage apparatus 3, which are configured for the ports.

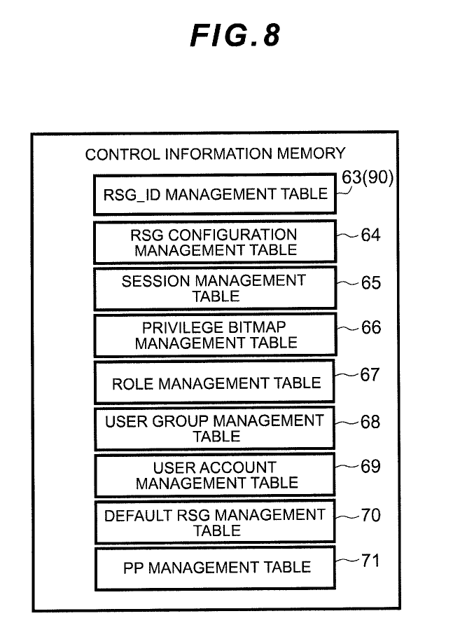

As means for implementing managing user access control processing using the aforementioned managing user access control system, the local memory 45 of the microprocessor package 33 of the storage apparatus 3 stores, as shown in FIG. 3, a resource group management program 60, a resource group control program 61, and an account management program 62, and the control information memory 47 of the cache memory package 34 of the storage apparatus 3 stores, as shown in FIG. 8, a resource group ID management table 63, a resource group configuration management table 64, a session management table 65, a privilege bitmap management table 66, a local management table 67, a user group management table 68, a user account management table 69, a default resource group ID management table 70, and a program product management table 71.

The resource group management program 60 is a program which includes a function for managing management target resources divided into a plurality of resource groups for each resource type. Furthermore, the resource group control program 61 is a program which manages the resource group ID management table 63, the resource group configuration management table 64, the session management table 65, and the default resource group ID management table 70, and comprises a function for updating a corresponding table or reading data from the table and transferring the data to the resource group control program 61 in response to a request from the resource group control program 61. In addition, the account management program 62 is a program which has a function for managing user accounts.

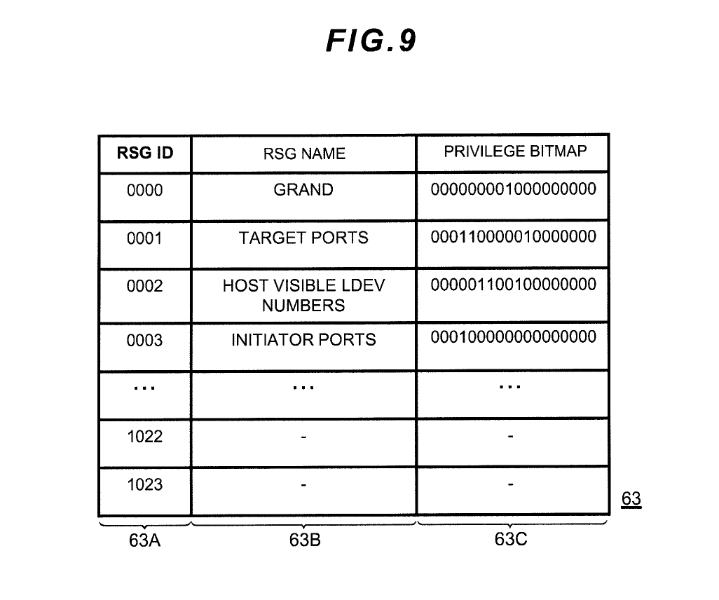

Meanwhile, the resource group ID management table 63 is a table which is used to manage created resource groups and, as shown in FIG. 9, is configured from a resource group ID field 63A, a resource group name field 63B, and a privilege bitmap field 63C.

Furthermore, the resource group ID field 63A stores an identifier (called a resource group ID hereinbelow) for the corresponding resource group RSG which is assigned by the managing user who created the resource group RSG or automatically when the resource group RSG is created, and the resource group name field 63B stores the name of the corresponding resource group RSG which is assigned by the managing user who created the resource group RSG or automatically when the resource group RSG is created.

Therefore, in the example of FIG. 9, it can be seen that, as the resource groups RSG, resource groups RSG, namely, ‘GRAND,’ ‘TARGET PORTS,’ ‘HOST VISIBLE LDEV NUMBERS,’ and ‘INITIATOR PORTS,’ . . . have already been created and these resource groups RSG are assigned resource group IDs, namely, ‘0000’, ‘0001’, ‘0002’, and ‘0003’.

Note that, in the case of this embodiment, the ‘GRAND’ resource group RSG which is assigned the resource group ID ‘0000’ is a resource group that exists by default, and all the resources prior to group division are configured so as to belong to the ‘GRAND’ resource group RSG.

This is because the configuration of resource groups RSG takes labor and time and the resources, before being distributed to any of the resource groups RSG by the managing user with the operating privileges, are all placed under the control of the ‘GRAND’ resource group RSG.

As a result, even initially before the required resource groups RSG are created by the managing user or when new resources are added, a state where a resource does not belong to any resource group RSG is prevented from arising, and the improper operation of a resource can be prevented before it happens.

Furthermore, the privilege bitmap field 63C stores a privilege bitmap in which a bit representing the privileges required to operate (create, modify or delete and so on) the corresponding default resource group RSG is configured as ‘1’. The privilege bitmap is the same as the privilege bitmap stored in the privilege bitmap field 70D for the default resource group ID management table 70 (described subsequently) with reference to FIG. 16 and hence the details of the privilege bitmap will be explained in FIG. 16.

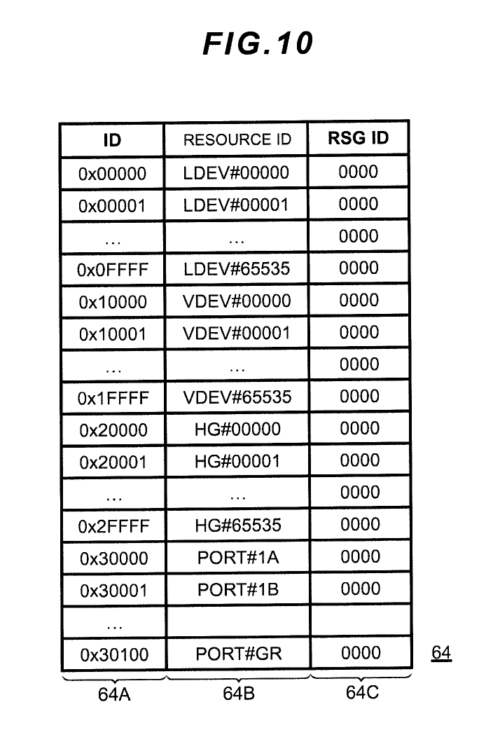

The resource group configuration management table 64 is a table which is used to manage the configuration of the resource groups RSG created in the storage apparatus 3 and, as shown in FIG. 10, is configured from an ID field 64A, a resource ID field 64B, and a resource group ID field 64C.

Furthermore, the ID field 64A stores unique serial numbers in the storage apparatus 3 which are respectively assigned to each management target resource. In addition, the resource ID field 64B stores identifiers (resource IDs) consisting of serial numbers for each of the resource types assigned to the corresponding resources, and the resource group ID field 64C stores the identifiers (resource group IDs) of the resource groups RSG to which the corresponding resources belong.

Hence, in the example in FIG. 10, it can be seen that the serial number ‘0x00000’ is assigned to the resource to which the resource ID ‘LDEV#00000’ is assigned, as the resource ID of the resource, and that this resource belongs to the ‘0000’ resource group RSG.

Note that, in FIG. 10, resources for which the resource IDs contain the character strings ‘LDEV,’ ‘VDEV,’ ‘HG,’ or ‘PORT’ represent the logical device numbers, virtual devices, host groups, or ports, respectively. Furthermore, FIG. 10 shows the initial state in which all the resources belong to the ‘GRAND’ resource groups RSG.

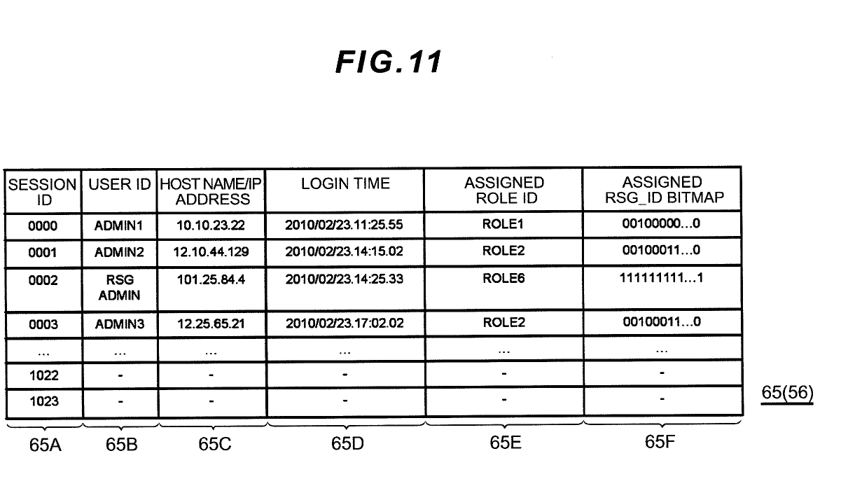

However, the session management table 65 is a table which is used to manage login sessions which are generated when managing users connect their own communication terminal device to the management apparatus 35 and log in to the storage apparatus 3 . As shown in FIG. 11, the session management table 65 is configured from a session ID field 65A, a user ID field 65B, a host name/IP address field 65C, a login time field 65D, an assigned role ID field 65E, and an assigned resource group ID bitmap field 65F.

Furthermore, the session ID field 65A stores identifiers (session IDs) unique to the login session assigned to the login session, and the user ID field 65B stores the identifiers (user IDs) of the managing users corresponding to the login session (the managing users who performed the login).

Furthermore, the host name/IP address field 65C stores identification information of the communication terminal devices used by the managing users which made the login (host names or IP addresses of the communication terminal devices), and the login time field 65D stores the time the login was made (the login time).

In addition, the assigned role ID field 65E stores the identifiers of the roles (role IDs) assigned to the user groups UG to which the managing users belong, and the assigned resource group ID bitmap field 65F stores a bitmap (hereinafter this is called the assigned resource group ID bitmap) in which the bit which corresponds to the resource group ID of the resource group RSG assigned to the managing user is raised to ‘1’.

Here, each of the bits in the assigned resource group bitmap corresponds to any of the resource groups RSG registered in the aforementioned resource group ID management table 63 in FIG. 9. More specifically, these bits are sequentially associated with the resource groups RSG with small resource group IDs, starting with the privilege end bit of the assigned resource group bitmap, so that the resource group ID of the privilege end bit of the assigned resource group bitmap corresponds to the resource group RSG (‘GRAND’) with the resource ID ‘0001’, the left-hand bit corresponds to the resource group RSG (‘TARGET PORTS’) with the resource ID ‘0002’, and the left-hand bit corresponds to the resource group RSG (‘HOST VISIBLE LDEV NUMBERS’) with the resource ID ‘0003’.

Therefore, in the case of the example in FIG. 11, it can be seen that the login session with the session ID ‘0001’ corresponds to a login performed by managing user ‘ADMIN1’ at ‘11:25:55 on 2010/02/23’ using the communication terminal device with the IP address ‘10.10.23.22’ and that this user is assigned a role ‘ROLE1’ and a resource group RSG which corresponds to at least the third bit from the left of the assigned resource group bitmap.

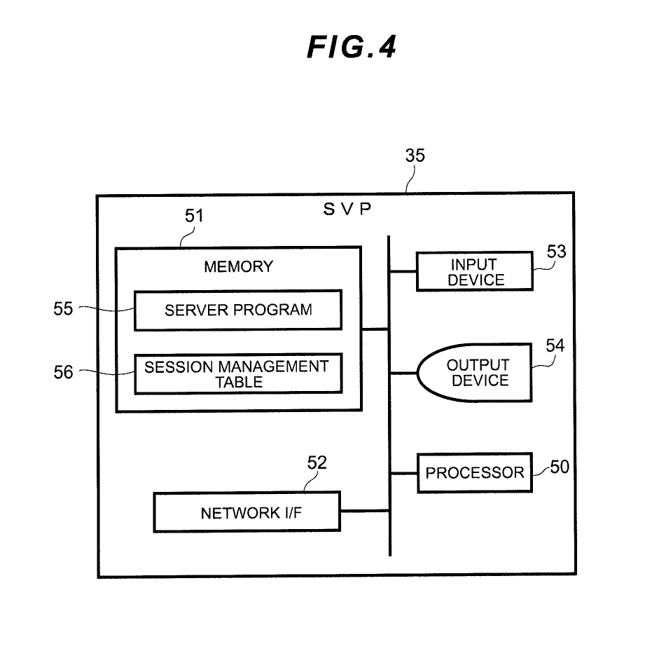

Note that the session management table 65 stored in the memory 51 of the management terminal 35 mentioned earlier with reference to FIG. 4 is created by copying the session management table 65 stored in the control information memory 47 (FIG. 3) of the cache memory package 34 (FIG. 3) of the storage apparatus 3. The session management table 56 held by the management terminal 35 and the session management table 65 stored in this control information memory 47 therefore have the same content.

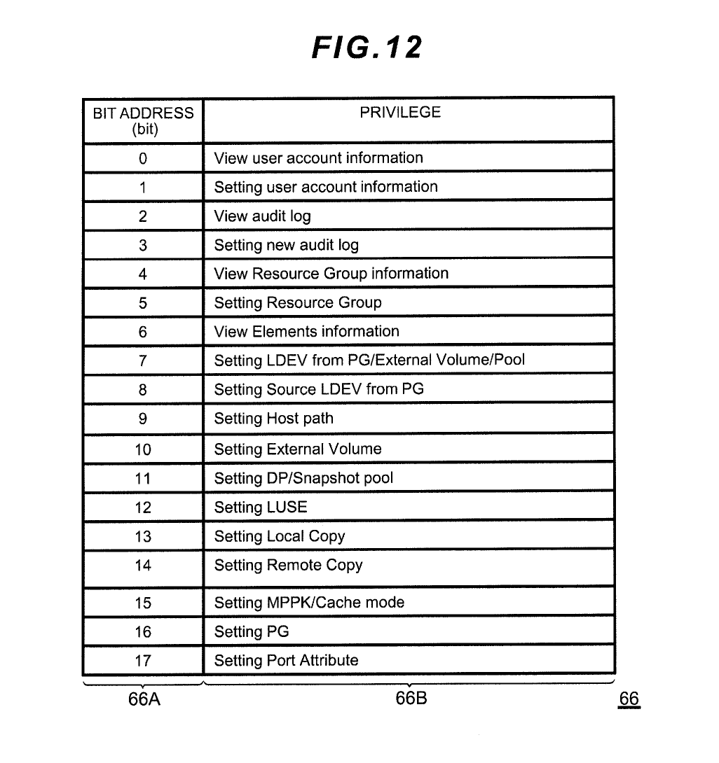

The privilege bitmap management table 66 is a table which is used to manage various predetermined privileges and, as shown in FIG. 12, is configured from a bit address field 66A and a privilege field 66B.

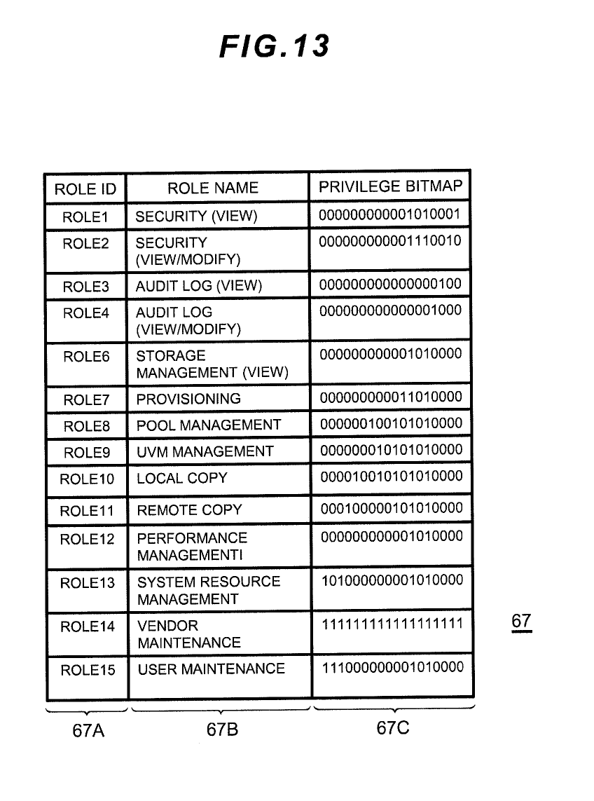

Furthermore, the bit address field 66A stores bit addresses for when the bit address of the left end bit is ‘0’ in the privilege bitmap of the role management table 67 described subsequently with reference to FIG. 13, and the privilege field 66B stores privileges associated with the bits of the bit addresses.

Hence, in FIG. 12, a privilege, namely, ‘View user account information,’ which is a privilege enabling browsing of user account information, is associated with a bit with a bit address ‘0’ of the privilege bitmap, and a privilege, namely, ‘Setting Host path,’ which is a privilege allowing the host bus to be configured, is associated with a bit with a privilege bitmap bit address of ‘9’, for example.

The role management table 67 is a table which is used to manage pre-configured roles and, as shown in FIG. 13, is configured from a role ID field 67A, a role name field 67B, and a privilege bitmap field 67C.

Furthermore, the role name field 67B stores the role name of each pre-defined role and the role ID field 67A stores an identifier (role ID) which is assigned to a corresponding role. In addition, the privilege bitmap field 67C stores a privilege bitmap in which privileges which can be executed by managing users with corresponding roles are described in bitmap format.

In the case of this embodiment, the privilege bitmap is an 18-bit configuration. Furthermore, as mentioned earlier, the bits in the privilege bitmap are associated respectively with any of the privileges registered in the privilege bitmap management table 66 (FIG. 12) according to the bit addresses.

Hence, in the case of the example in FIG. 13, it can be seen that the role with the role name ‘PROVISIONING’ and the role ID ‘ROLE7’, for example, is configured from a privilege called ‘View Resource Group information,’ a privilege called ‘View Elements information’ which is a privilege for browsing information on each resource in the corresponding resource group RSG, and a privilege called ‘Setting LDEV from PG/External Volume/Pool’ which is a privilege for creating a logical device from a parity group, external volume EXT-VOL or pool volume POOL.

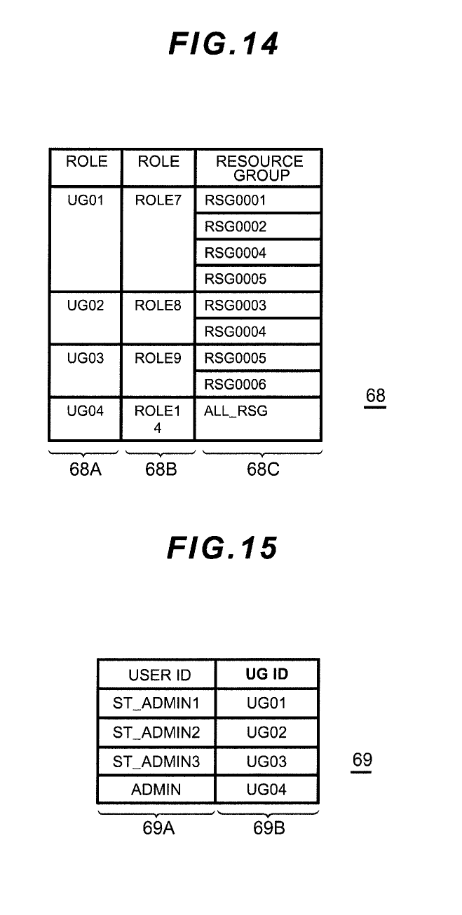

The user group management table 68 is a table which is used to manage each of the user groups UG configured by the managing user with the operating privileges and, as shown in FIG. 14, is configured from a user group ID field 68A, a role field 68B, and a resource group field 68C.

Furthermore, the user group ID field 68A stores the identifiers of each of the user groups UG (user group IDs) defined in the storage apparatus 3, and the resource group field 68C stores the identifiers of each of the resource groups RSG (resource group IDs) assigned to the corresponding user groups UG.

Furthermore, the role field 68B stores the identifiers of each of the roles (role IDs) which are assigned to the corresponding user groups UG. In this case, a plurality of roles can be assigned to the user groups UG. Furthermore, in cases where a plurality of roles are assigned to the user groups UG, the role field 68B in the user group management table 68 stores the role IDs of all the roles assigned to the user groups UG.

Therefore, in the case in FIG. 14, it can be seen that the role known as ‘ROLE7’ and the resource groups RSG known as ‘RSG0001’, ‘RSG002’, ‘RSG004’, and ‘RSG005’ can be respectively assigned to the user group UG called ‘UG01’, for example.

Hence, in FIG. 14, the role ‘ROLE14’ assigned to the user group UG ‘UG04’ is a privilege which includes all privileges defined in FIG. 12, and ‘ALL_RSG’ assigned to the user groups UG include all the resource groups RSG defined in the storage apparatus 3. Hence, the users belonging to the user group UG ‘UG04’ have all the privileges for all the management target resources in the storage apparatus 3.

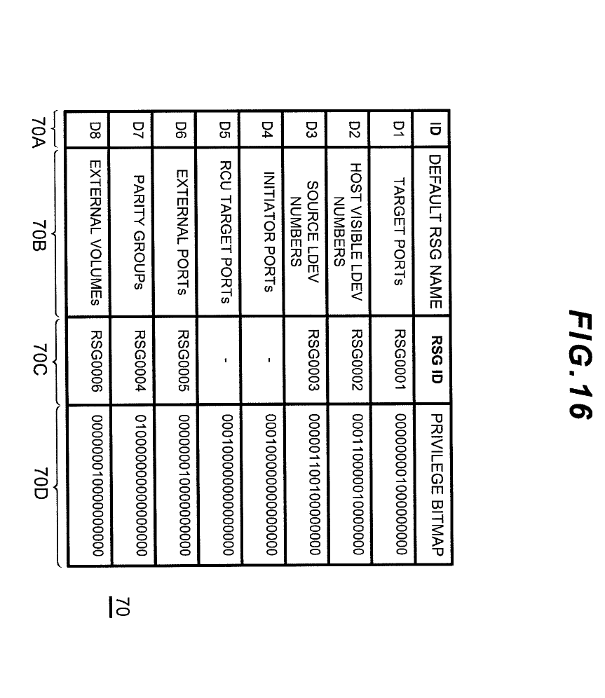

Meanwhile, the user account management table 69 is a table which is used to manage the user groups UG to which each of the users belong and, as shown in FIG. 15, is configured from a user ID field 69A, and a user group ID field 69B. Furthermore, the user ID field 69A stores the user IDs of each of the registered managing users, and the user group ID field 69B stores the user group IDs of the user groups UG to which the corresponding managing user belongs.

Therefore, in the case of FIG. 15, it can be seen that the managing user ‘ST_ADMIN1’ belongs to the user group UG ‘UG01’.

Note that, with this embodiment, the managing users are able to belong to the plurality of user groups UG, and hence, if the corresponding managing user belongs to a plurality of the user groups UG, the user group ID field 69B stores a plurality of user group IDs.

The default resource group ID management table 70 is a table which is used to manage resource groups defined by way of default (hereinafter referred to as default resource groups) RSG and, as shown in FIG. 16, is configured from a default resource group ID field 70A, a default resource group name field 70B, a resource group ID field 70C, and a privilege bitmap field 70D.

Furthermore, the default resource group ID field 70A stores identifiers (hereinafter called default resource group IDs) which are assigned to the corresponding default resource groups RSG, and the default resource group name field 70B stores the resource group names assigned to the corresponding default resource groups RSG. In addition, the resource group ID field 70A stores the resource group IDs of the corresponding default resource groups RSG.

Furthermore, the privilege bitmap field 70D stores a privilege bitmap in which a bit representing the privilege required to operate (create, modify or delete and so on) the corresponding default resource group RSG is configured as ‘1’. The bits in the privilege bitmap are each associated respectively with any of the privileges registered in the privilege bitmap management table 66 mentioned earlier with reference to FIG. 12 according to the bit addresses. For example, the bit (privilege end bit) with the bit address ‘0’ corresponds to the privilege called ‘View user account information’, the bit (second bit from the privilege end) with the bit address ‘1’ corresponds to the privilege known as ‘Setting user account information’, and the bit (left end bit) with the bit address ‘17’ corresponds to the privilege ‘Setting Port Attribute.’

Hence, in FIG. 16, it can be seen that eight default resource groups RSG are defined by default in the storage apparatus 3, namely ‘TARGET PORTs,’ ‘HOST VISIBLE LDEV NUMBERS,’ ‘SOURCE LDEV NUMBERS,’ ‘INITIATOR PORTs,’ ‘RCU TARGET PORTs,’ ‘EXTERNAL PORTS,’ ‘PARITY GROUPs,’ and ‘EXTERNAL VOLUMEs’ each with the default resource group IDs ‘D1’ to ‘D8.’ In addition, in the case of FIG. 16, for example, it can be seen that a privilege called ‘Setting Host path,’ which is a privilege for configuring the host path is required in order to operate the default resource group RSG ‘TARGET PORTs.’

Note that if the plurality of bits are configured as ‘1’ in the privilege bitmap, as long as there is a single privilege among the privileges corresponding to each bit configured as ‘1’, the default resource group RSG can be operated. Therefore, it can be seen that, in order to operate the default resource group RSG (the resource group ID is ‘RSG0003’), namely ‘SOURCE LDEV NUMBERS,’ which is a collection of logical devices forming the pool, for example, any of the following privileges is required: the privilege known as ‘View Resource Group information,’ which corresponds to the fifth bit from the privilege end of the privilege bitmap, the privilege known as ‘View Elements information,’ which corresponds to the seventh bit from the privilege end of the privilege bitmap, and the privilege known as ‘Setting LDEV from PG/External Volume/Pool,’ which corresponds to the eight bit from the privilege end of the privilege bitmap.

Furthermore, the program product management table 71 is a table which is used to manage the usage privilege of the programs which are pre-installed in the storage apparatus 3, and is configured from the program product field 71A, the target default resource group ID field 71B and the license installation field 71C.

Further, the program product field 71A stores the names of each of the vendor-prepared programs, and the target default resource group ID field 71B stores the default resource group ID of the default resource group RSG which is the processing target based on the corresponding program.

In addition, the license installation field 71C stores a flag indicating whether or not a license which employs the corresponding program has been installed (hereinafter called the license installation flag). Note that when this license installation flag is ‘1’, this indicates that the corresponding license (whereby the usage privilege for the corresponding program product is obtained) is installed, and when the license installation flag is ‘0’, this indicates that the license has not been installed (whereby the usage privilege for the corresponding program has not been obtained).

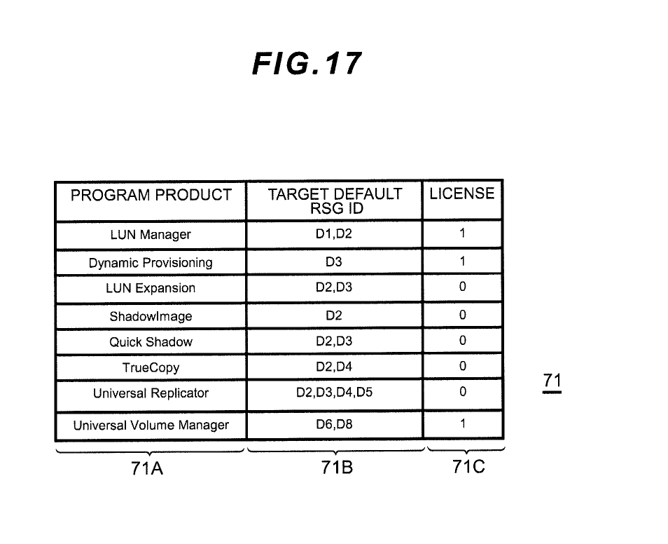

Therefore, in the case of FIG. 17, it can be seen that the program known as ‘LUN Manager’ is a program for operating the default resource groups RSG known as ‘D1’ and ‘D2’, and that this program has already been installed (the license installation flag is ‘1’).

(1-3) Various Processing Relating to Access Control System According to this Embodiment.

The flow of various processing which is executed in the storage apparatus 3 and relates to the access control system according to this embodiment will be described next. Note that although the various processing is described hereinbelow with the focus on the ‘program’, it goes without saying that, in reality, the microprocessor (hereinafter called the main microprocessor) 43 provided in a specified microprocessor package 33 among the plurality of microprocessor packages 33 (FIG. 3) provided in the storage apparatus 3, or the processor 50 of the management terminal 35 (FIG. 4) executes this processing on the basis of this program.

(1-3-1) Default Resource Group Creation Processing

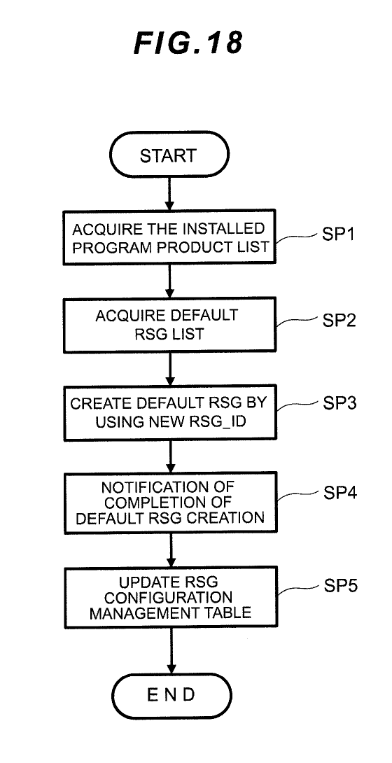

FIG. 18 shows the processing routine of the default resource group creation processing which is executed by the resource group management program 60 (FIG. 3) on the basis of a default resource group creation command sent to the main microprocessor 43 from the server program 55 (FIG. 4) of the management terminal 35 in response to an instruction by the managing user with operating privileges to create a default resource group RSG by operating the communication terminal device connected to the management terminal 35 (FIG. 3) of the storage apparatus 3, initially before the operation of the storage apparatus 3 is started, or after the operation is started.

With this embodiment, initially, before the storage apparatus 3 starts operating, a resource group ID is not assigned to any of the default resource groups RSG and therefore the resource group ID field 70C (FIG. 16) of the default resource group ID management table 70 (FIG. 16) is an empty field. Accordingly, at this stage, the resources are not assigned to any of the default resource groups RSG, and the default resource groups RSG are formal yet insubstantial.

When the default resource group creation command is issued from the server program 55 of the management terminal 35, the resource group management program 60 assigns a resource group ID to the required default resource group RSG and, by assigning a resource designated by the managing user with the operating privileges to the default resource group RSG, the resource group management program 60 creates a substantial default resource group RSG.

In reality, the resource group management program 60 starts the default resource group creation processing when a default resource group creation command is supplied from the management terminal 35. The resource group management program 60 then first refers to the program product management table 71 (FIG. 17) and acquires a list of programs which are installed on the storage apparatus 3 (program products for which ‘1’ is stored in the license installation field) (SP1).

The resource group management program 60 then acquires all the default resource group IDs stored in the target default resource group ID field 71B for the entry which corresponds to each of the programs appearing in a list which is acquired in step SP1 from among the entries (rows) in the program product management table 71 (FIG. 17) (SP2).

Thereafter, the resource group management program 60 creates (validates) the default resource groups RSG by assigning resource group IDs to the default resource groups RSG to which the default resource group IDs acquired in step SP2 have been assigned (SP3). Specifically, the resource group management program 60 stores the different unique resource group IDs in the resource group ID field 70C (FIG. 16) of each of the entries corresponding to each of the default resource groups RSG to which the default resource group IDs acquired in step SP2 have been assigned from among the entries in the default resource group ID management table 70 (FIG. 16) respectively.

The resource group management program 60 then notifies the management terminal 35 that the creation of the required default resource groups RSG is complete (SP4).

The server program 55 of the management terminal 35 which received the notification displays, on the communication terminal device connected to the management terminal 35, a resource designation screen (not shown) with which the managing user designates the resources which each of the default resource groups RSG created in step SP3 comprise. Thus, the managing user with the operating privileges uses the resource designation screen to designate one or more resources which the default resource groups RSG comprise with reference to each of the default resource groups RSG created in step SP3. The operating content of the managing user at that time is then notified to the resource group management program 60.

Upon receiving this notification, the resource group management program 60 updates the resource group configuration management table 64 (FIG. 10) such that the resources belong to the default resource group RSG to which these resources each correspond for each of the resources designated on the resource designation screen as mentioned earlier (SP5). Specifically, the resource group management program 60 overwrites the resource group IDs stored in the resource group ID field 64C for the entries corresponding to resources in the resource group configuration management table 64 with the resource group ID of the corresponding default resource group RSG.

The resource group management program 60 subsequently ends the default resource group creation processing.

(1-3-2) User Group Creation Processing

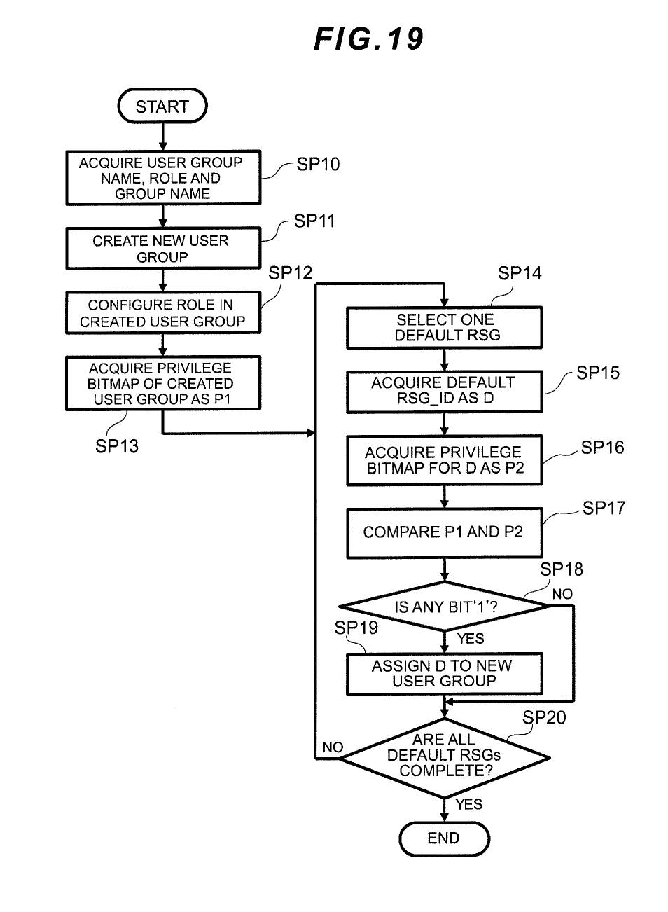

However, FIG. 19 shows the processing routine of the user group creation processing which is executed by the account management program 62 (FIG. 3) on the basis of a user group creation command sent to the main microprocessor 43 from the server program 55 (FIG. 4) of the management terminal 35 in response to an instruction by the managing user with operating privileges to create a new user group UG by operating the communication terminal device connected to the management terminal 35 (FIG. 3) of the storage apparatus 3, initially before the operation of the storage apparatus 3 is started, or after the operation is started. The account management program 62 creates a new user group UG according to the processing routine shown in FIG. 19.

In other words, in the storage apparatus 3, the communication terminal device connected to the management terminal 35 is operated by a managing user with the operating privileges and the group names (user group IDs) of the user groups UG to be newly created and roles which are to be assigned to the user groups UG are designated, and when an instruction to create a user group UG is subsequently input, a corresponding user group creation command is issued to the main microprocessor 43.

When the user group creation command is supplied, the account management program 62 starts the user group creation processing and first acquires the group name of the new user group UG contained in the user group creation command and the role which is to be assigned to the user group UG (SP10).

The account management program 62 then creates the requested new user group UG (SP11). Specifically, the account management program 62 adds a new entry (row) to the user group management table 68 (FIG. 14) and stores a user group ID that is specific to the user group UG assigned to the new user group UG in the user group ID field 68A for this entry.

The account management program 62 then assigns a role to the new user group UG created in step SP11 (SP12). Specifically, the account management program 62 stores the role ID of the role designated by the managing user acquired in step SP10 in the entry role field 68B (FIG. 14) added to the user group management table 68 in step SP11

In addition, the account management program 62 subsequently acquires the privilege bitmap for the newly created user group UG as ‘P1’ (SP13).

More precisely, the account management program 62 acquires the privilege bitmap for the roles assigned to the user group UG in step SP12 from the role management table 67 (FIG. 13) as ‘P1’.

Thereafter, the account management program 62 selects one default resource group RSG to which a resource group ID has been assigned from among the default resource groups RSG registered in the default resource group ID management table 70 (FIG. 16) (SP14), and acquires the resource group ID of this default resource group RSG as ‘D’ (SP15).

Thereafter, the account management program 62 acquires a privilege bitmap of the default resource group RSG to which the resource group ID ‘D’ was assigned from the default resource group ID management table 70 as ‘P2’ (SP16).

In addition, the account management program 62 compares the privilege bitmap ‘P1’ acquired in step SP13 with the privilege bitmap ‘P2’ acquired in step SP16 (SP17) and determines whether or not, among the bits in the privilege bitmap ‘P1’, the bits corresponding to the bits configured as ‘1’ in the privilege bitmap ‘P2’ are ‘1’ (SP18).

The account management program 62 advances to step SP20 upon obtaining a negative result in this determination, whereas when an affirmative result is obtained, the default resource group RSG selected in step SP14 is assigned to the new user group UG (SP19). Specifically, the account management program 62 stores the resource group ID of the default resource group RSG in the resource group field 68C of the entry added to the user group management table 68 (FIG. 14) in step SP11.

Note that if there are a plurality of bits configured as ‘1’ in the privilege bitmaps ‘P2’ (privilege bitmaps ‘D2’ and ‘D3’ in FIG. 16, for example), as long as at least one of the bits in the privilege bitmap ‘P1’ which corresponds to these bits is configured as ‘1’, it is assumed that the account management program 62 obtains an affirmative result in step SP18.

Thereafter, the account management program 62 determines whether or not execution of the same processing is complete for all the default resource groups RSG which are registered in the default resource group ID management table 70 and to which a resource group ID has been assigned (SP20) and returns to step SP14 when a negative result is obtained.

Furthermore, the account management program 62 subsequently repeats the processing of steps SP14 to SP20 while sequentially switching the default resource group RSG selected in step SP14 to another unprocessed default resource group RSG. As a result, all the default resource groups RSG which can be operated according to the roles assigned to the user group UG (all the default resource groups RSG which can be operated within the scope of the operating privileges assigned to the user group UG) come to be assigned to the new user group UG.

In addition, upon obtaining an affirmative result in step SP20 as a result of completing the execution of the same processing for all the default resource groups RSG which are already registered in the default resource group ID management table 70 and to which a resource group ID has been assigned, the account management program 62 ends the user group creation processing.

(1-3-3) Login Processing

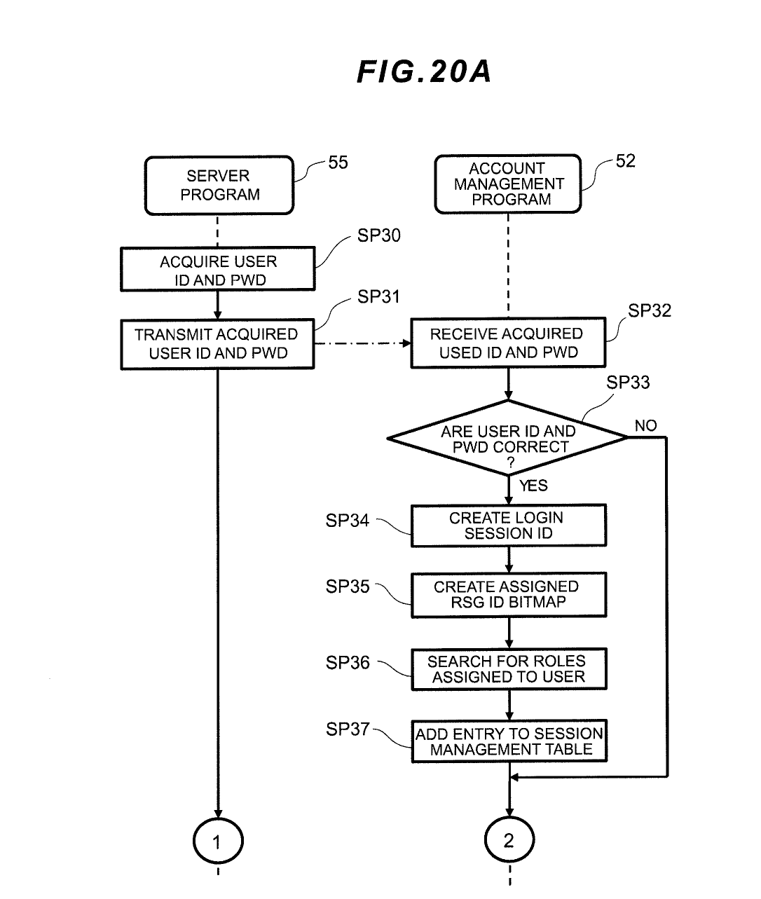

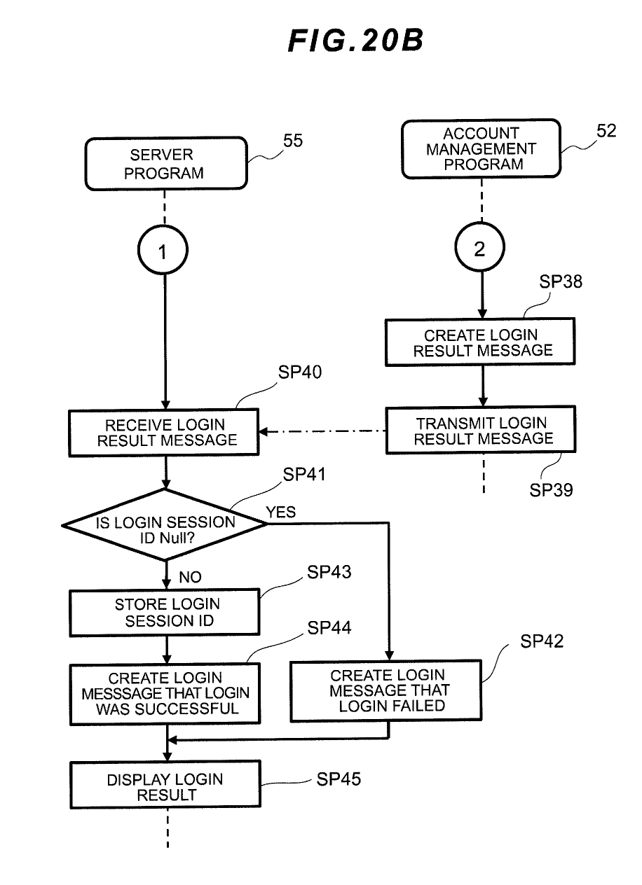

However, FIGS. 20A and 20B show the flow of the login processing which is executed by the account management program 62 of the storage apparatus 3 and the server program 55 of the management terminal 35 when, after the storage apparatus 3 starts operating, the managing user operates the communication terminal device connected to the management terminal 35 to log on to the storage apparatus 3. The server program 55 and the account management program 62 process login requests from the user according to the flow shown in FIGS. 20A and 20B.

In other words, the server program 55 starts the login processing shown in FIGS. 20A and 20B when the managing user operates the communication terminal device connected to the management terminal 35 and requests a login by inputting a user ID and password (PWD) of the managing user. Furthermore, the server program 55 first acquires the user ID and password input by the user (SP30) and transmits the acquired user ID and password to the account management program 62 (SP31).

Upon receipt of the user ID and password (SP32), the account management program 62 compares the user ID and password combination for each pre-managed user with the user ID and password combination received in step SP32, and determines whether or not the user ID and password combination received in step SP32 is correct (SP33).

The account management program 62 advances to step SP38 upon obtaining a negative result in this determination, however when an affirmative result is obtained, the account management program 62 creates a login session ID for this login (SP34). Note that, in this embodiment, serial numbers are assigned as these login session IDs. Furthermore, if there is a number missing from an already assigned login session ID, this missing number is used as a login session ID for a new login.

Thereafter, the account management program 62 searches the user account management table 69 (FIG. 15) for the user group UG to which the managing user belongs, searches the user group management table 68 (FIG. 14) for the resource group RSG assigned to this user group UG, and creates an assigned resource group ID bitmap (see the assigned resource group ID bitmap field 65F in FIG. 11) for the managing user on the basis of this search result (SP35).

Thereafter, the account management program 62 searches the user group management table 68 for the roles assigned to the user group UG to which this managing user belongs and, based on the search result, refers to the role management table 67 (FIG. 13) to search for the roles assigned to the user group UG (SP36).

The account management program 62 then adds and registers a new entry for the login at the time to the session management table 65 (FIG. 11) on the basis of the processing result of steps SP33 to SP36 (SP37).

Specifically, the account management program 62 reserves a new entry (row) in the session management table 65, and stores the login session ID created in step SP34, the user ID received in step SP32, the IP address of the transmission source host computer 2 of the user ID and so forth obtained when the user ID and so forth were received in step SP32, and the login time which is the time the user ID and so on were received in step S32, in the session ID field 65A, the user ID field 65B, the host name/IP address field 65C, and the login time field 65D respectively for this entry.

Furthermore, the account management program 62 stores the role IDs of all the roles detected in the search of step SP36 in the assigned role field 65E for this entry, and stores the assigned resource group ID bitmap created in step SP35 in the assigned resource group ID bitmap field 65F of this entry.

Thereafter, the account management program 62 creates a login result message indicating whether or not a login has been successful (SP38), and ends the login processing after transmitting the created login result message to the communication terminal device connected to the management terminal 35 (SP39).

Note that this login result message includes a login session ID, and when the managing user is authenticated in the authentication processing of step SP33 (when the login has been successful), the login session ID created in the step SP34 as a login session ID is stored in the login result message, and when the managing user has not been authenticated in this authentication processing (when the login has failed), ‘Null’ is stored as the login session ID.

However, upon receiving the login result message transmitted from the account management program 62 (SP40), the server program 55 extracts the login session ID contained in the login result message and determines whether or not the login session ID is ‘Null’ (SP41).

Furthermore, upon obtaining an affirmative result in this determination, the server program 55 creates a login message to the effect that the login has failed (SP42), and displays the created login message on the communication terminal device connected to the management terminal 35 (SP45). The server program 55 then terminates the login processing.

However, upon obtaining a negative result in the determination of step SP41, the server program 55 stores the login session ID extracted from the login result message (SP43). Furthermore, the server program 55 creates a login message to the effect that the login has succeeded (SP44), and ends the login processing after the created login message is displayed (SP45).

(1-3-4) Request Reception Processing

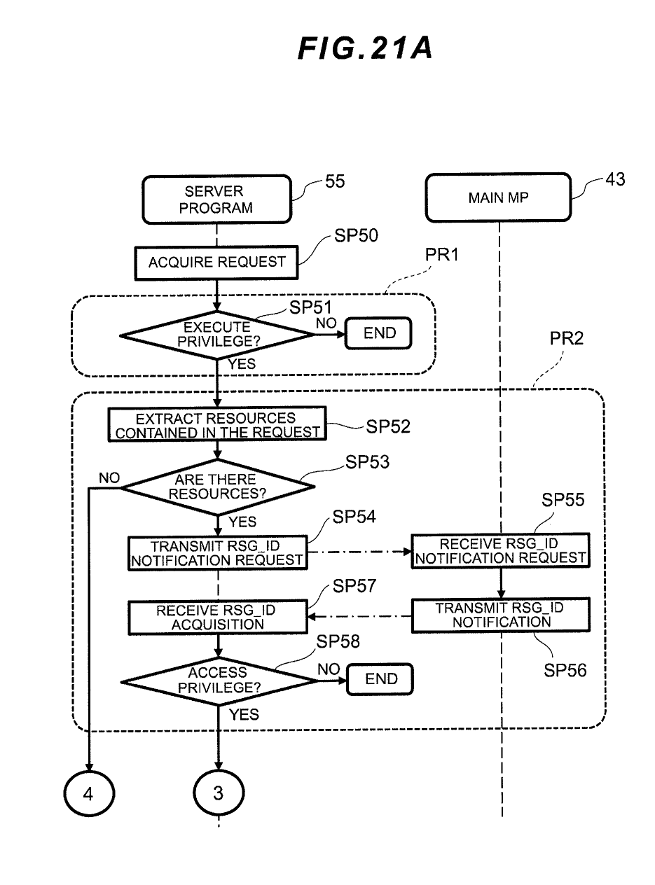

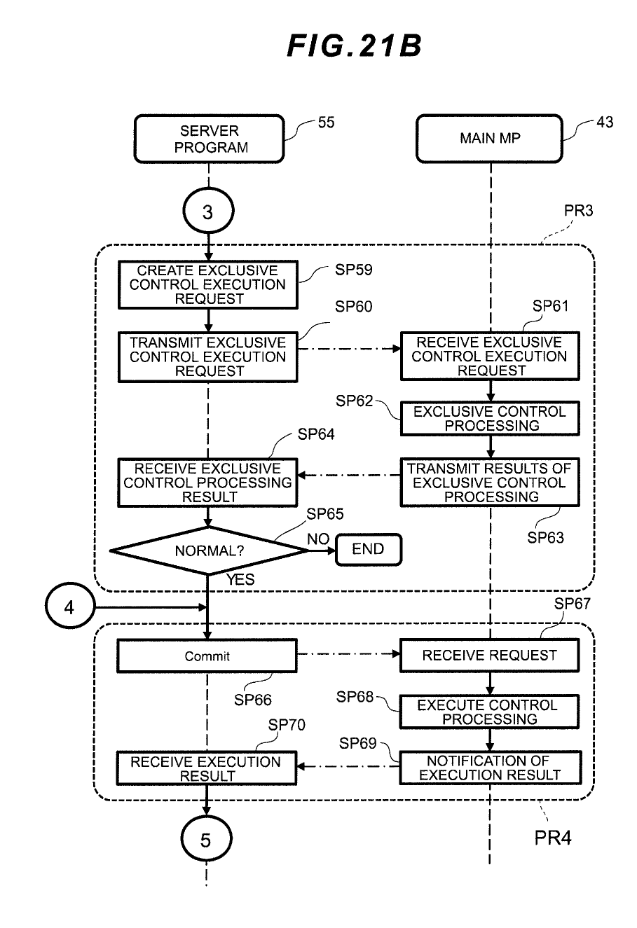

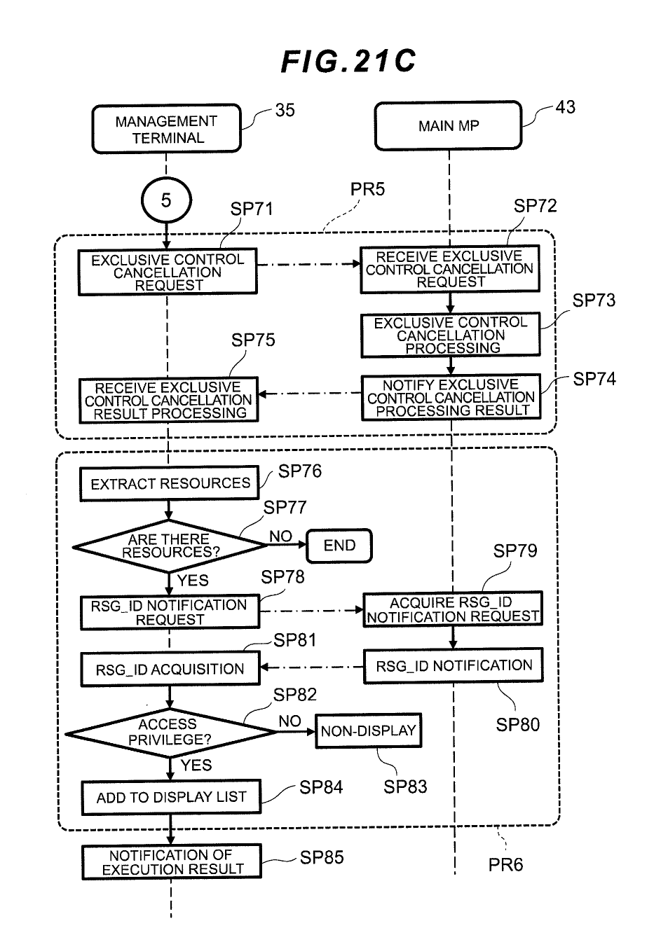

Meanwhile, FIGS. 21A to 21C show the flow of request reception processing which is executed by the server program 55 of the management terminal 35 and the main micro-processor 43 when the managing user who logged on orders any management operation of resources by operating the communication terminal device connected to the management terminal 35 of the storage apparatus 3.

This request reception processing is configured from execution privilege check processing PR1, resource group access check processing PR2, exclusive control execution processing PR3, commit processing PR4, exclusive control cancellation processing PR5, and return value filtering processing PR6, and the server program 55 and main microprocessor 43 processes requests from the managing user according to the flow shown in FIGS. 21A to 21C.

In other words, upon receiving a request to execute any management operation on the resources input as a result of the managing user operating the communication terminal device connected to the management terminal 35 (SP50), the server program 55 de-termines whether or not the managing user has the privilege to execute the management operation which is designated in the request (SP51).

More specifically, in step SP51, the server program 55 acquires the roles assigned to the managing user from the assigned role ID field 65E for the corresponding entry in the session management table 56 (see FIG. 11) which is stored in the memory 51 (FIG. 4) of the management terminal 35, and detects the privilege assigned to the managing user by referring to the role management table 67 (FIG. 13) and the privilege bitmap management table 66 (FIG. 12). Furthermore, the server program 55 extracts the operation requested by the managing user from the request acquired in step SP50, and determines whether or not the operation is included in the privilege supplied to the managing user detected as mentioned earlier.

Upon obtaining a negative result in this determination, the server program 55 displays an error message to the effect that the managing user does not possess the privilege to execute the required operation on the communication terminal device connected to the management terminal 35, and then ends the request reception processing.

However, upon obtaining an affirmative result in the determination of step SP51, the server program 55 extracts resource IDs of operation target resources from the request (SP52). Here, if the resources indicated by the collection of resources targeted by the resource group function are included in the request, the server program 55 extracts all the resources targeted by the resource group function forming the resources. The server program 55 subsequently determines whether or not the resource ID of any resource has been extracted (SP53).

Furthermore, the server program 55 advances to step SP66 upon obtaining a negative result in this determination, but upon obtaining an affirmative result, the server program 55 issues a request to the main microprocessor 43 (hereinafter this request is called a resource group ID notification request) to notify the resource group ID of the resource group RSG to which the resource belongs (SP54).

In addition, upon receiving this resource group ID notification request (SP55), the main microprocessor 43 refers to the resource group configuration management table 64 (FIG. 10), detects the resource group ID of the resource group RSG to which the resource belongs and transmits the detected resource group ID to the server program 55 (SP56).

Upon receipt of the resource group ID (SP57), the server program 55 refers to the assigned resource group ID bitmap stored in the assigned resource group ID bitmap field 65F of the corresponding entry in the session management table 65, and determines whether or not the privilege for accessing the resource group RSG with this resource group ID is possessed by the managing user (SP58).

Upon obtaining a negative result in this determination, the server program 55 displays a predetermined error message, on the communication terminal device connected to the management terminal 35, to the effect that the managing user does not possess the privilege to access the resource group RSG, and subsequently ends the request reception processing.

However, upon obtaining an affirmative result in the determination of step SP58, the server program 55 creates an exclusive control execution request in a predetermined format (SP59), and transmits the created exclusive control execution request to the main microprocessor 43 (SP60).

In addition, upon receipt of the exclusive control execution request (SP61), the main microprocessor 43 executes exclusive control processing to lock the login session ID of the managing user, who is determined as having the execution privilege in step SP51, as the owner, for the resource groups RSG to which the resource group ID acquired in step SP56 is assigned (SP62). Thus, the main microprocessor 43 subsequently rejects requests if a request from another managing user targeting a resource belonging to the resource group RSG is received.

Thereafter, the main microprocessor 43 notifies the processing result of the exclusive control processing executed in step SP62 to the server program 55 (SP63).

However, upon receiving this notification (SP64), the server program 55 determines whether or not the exclusive control processing of step SP62 ends normally (SP65). Upon obtaining a negative result in this determination, the server program 55 displays a predetermined error message to the effect that the exclusive control processing has ended normally on the communication terminal device connected to the management terminal 35, and subsequently ends the request reception processing.

However, upon obtaining an affirmative result in the determination of step SP65, the server program 55 transmits the request received in step SP50 to the main micro-processor 43 (SP66).

Furthermore, upon receiving this request (SP67), the main microprocessor 43 executes control processing corresponding to the request (SP68) and notifies the control processing execution result to the server program 55 (SP69).

Furthermore, upon acquiring the control processing execution result as a result of this notification (SP70), the server program 55 transmits an exclusive control cancellation request to request cancellation of the locking (exclusive control) of the resource groups RSG targeted by the exclusive control request transmitted to the main microprocessor 43 in step SP60 to the main microprocessor 43 (SP71).

Furthermore, upon receiving this exclusive control cancellation request (SP72), the main microprocessor 43 executes an exclusive control cancellation processing to cancel the locking of the resource group RSG in a locked state in step SP62 (SP73), and notifies the processing result of the exclusive control cancellation processing to the server program 55 (SP74).

Upon receiving the processing result of the exclusive control cancellation processing (SP75), the server program 55 extracts the resource IDs of the resources contained in the return value (SP76) and then determines whether or not it has been possible to extract the resource IDs of any resources (SP77). Note that this step SP77 involves processing to determine whether or not an access check (filtering) should be performed because this filtering must be executed if the resources targeted by the resource group function are contained in the return value.

Upon obtaining a negative result in this determination, the server program 55 ends the request reception processing, but upon obtaining an affirmative result, the server program 55 transmits, to the main microprocessor 43, a request to the effect that notification should be made of the resource group ID of the resource group RSG to which the resource ID extracted from the return value in step SP76 belongs (hereinafter this is called a resource group ID notification request) (SP78).

Upon receiving this resource group ID notification request (SP79), the main micro-processor 43 searches the resource group configuration management table 64 (FIG. 10) for the resource group ID of the resource group RSG to which the resource belongs, and notifies the server program 55 of the resource group ID obtained (SP80).

Upon acquiring this resource group ID from this notification (SP81), the server program 55 refers to the assigned resource group ID bitmap field 65F (FIG. 11) of the session management table 56 (FIG. 4), and determines whether or not the managing user possesses operating privileges for the resource group RSG to which the resource group ID has been assigned (SP82).

Furthermore, upon obtaining a negative result in this determination, the server program 55 does not display information relating to the corresponding resources on the management terminal 35 (SP83), but when an affirmative result is obtained, the server program 55 adds the resources to the predetermined display list (not shown) and displays the management operation processing result, designated by the managing user, on the management terminal 35 for the resources registered in the display list (SP85).

The server program 55 then terminates the request reception processing.

(1-4) Effect of the Embodiment

As described above, in the computer system 1 according to this embodiment, a resource group RSG is formed from one or more resources of the same type and only the resource groups RSG which can be operated according to the roles assigned to the user groups UG are assigned to each of the user groups UG, and hence the scope of exclusive control can be configured in just proportion.

As a result, while the operating interference between managing users is reduced, since management operation parallel processing can be carried out on each of the resources, the convenience and user friendliness of the storage apparatus 3 can be gradually improved.

### (2) Second Embodiment

(2-1) Configuration of a Computer System According to this Embodiment

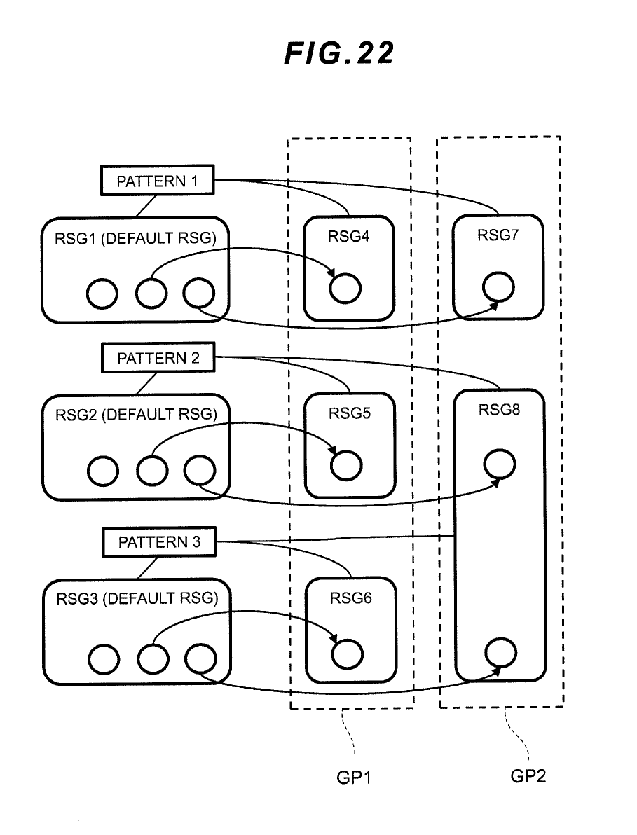

In FIG. 1, 80 denotes the whole computer system according to the second embodiment. In the computer system 80, as shown in FIG. 22, normal resource groups RSG which are substantial can be formed by moving some or all of the resources of the default resource groups RSG to the newly created formal resource groups (resource groups to which a resource group ID has been assigned but in which there are no resources) RSG.

Furthermore, one characteristic of this computer system 80 is that this system 80 manages a plurality of resource groups RSG collectively as a single group GP (GPI, GP2, . . . ), and that only those resource groups RSG which belong to the group GP designated for the managing user can be assigned to the managing user.

In other words, in the computer system 1 according to the first embodiment, when the resource groups RSG defined in the storage apparatus 3 are assigned to the user groups UG, all the resource groups RSG which can be operated according to the roles assigned to the user groups UG are assigned. Therefore, for example, if the storage apparatus 81 is shared by a plurality of organizations (companies, divisions and so on), the managing users of each of the organizations are then able to manage and operate the resources (resource groups RSG) which are not assigned to their own organization.

Hence, in the computer system 80 according to the second embodiment, since it is only possible to assign to managing users those resource groups RSG which belong to the group GP designated for the managing users, even in cases where the storage apparatus 81 is shared by a plurality of organizations to the managing users, the managing users of each of the organizations are only able to manage and operate the resources which have been assigned to their own organization. Note that the computer system 80 according to this embodiment is the same as the computer system 1 according to the first embodiment in the configuration of its parts other than this characteristic configuration.

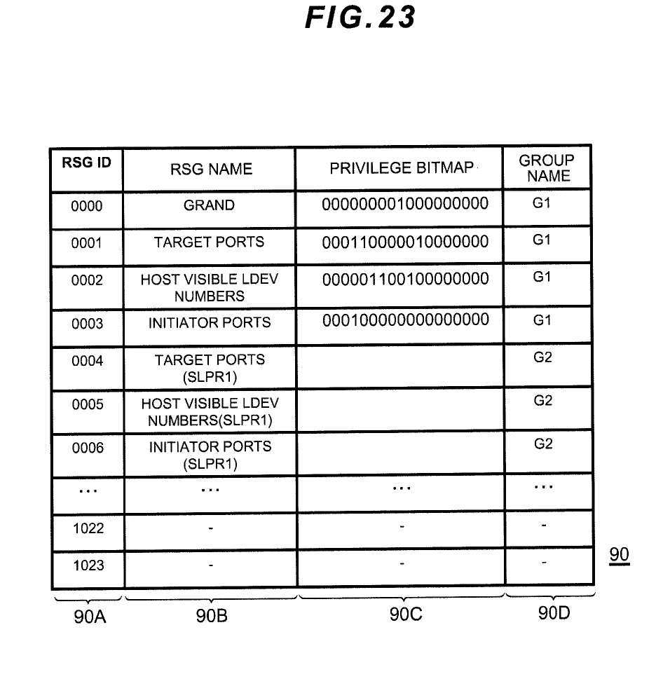

As means for implementing the characteristic configuration according to this em-bodiment, in the case of this computer system 80, the control information memory 47 (FIG. 3) of the storage apparatus 81 stores the resource group ID management table 90 shown in FIG. 23 instead of the resource group ID management table 63 described earlier with reference to FIG. 9.

However, the resource group ID management table 90 is a table which is used to manage resource groups created by managing users with operating privileges and, as shown in FIG. 23, is configured from a resource group ID field 90A, a resource group name field 90B, a privilege bitmap field 90C and a group name field 90D.

Furthermore, the resource group ID field 90A, the resource group name field 90B, and the privilege bitmap field 90C respectively store the same information as the information stored in the resource group ID field 63A (FIG. 9), the resource group name field 63B (FIG. 9), and the privilege bitmap field 63C (FIG. 9) in the resource group ID management table 63 according to the first embodiment described earlier with reference to FIG. 9. Furthermore, the group name field 90D stores the group name of the group GP to which the corresponding resource group RSG belongs.

Therefore, in FIG. 23, it can be seen that the resource groups RSG with the resource group IDs ‘0000’ to ‘0003’, namely, ‘GRAND,’ ‘TARGET PORTS,’ ‘HOST VISIBLE LDEV NUMBERS' and ‘INITIATOR PORTS,’ all belong to the group GP with the group name ‘GI’ and the resource groups RSG with the resource group IDs ‘0004’ to ‘0006’, namely, ‘TARGET PORTS (SLPR1),’ ‘HOST VISIBLE LDEV NUMBERS (SLPR1)’ AND ‘INITIATOR PORTS (SLPR1)’ all belong to the group GP with the group name ‘G2’.

(2-2) Resource Group Creation Processing

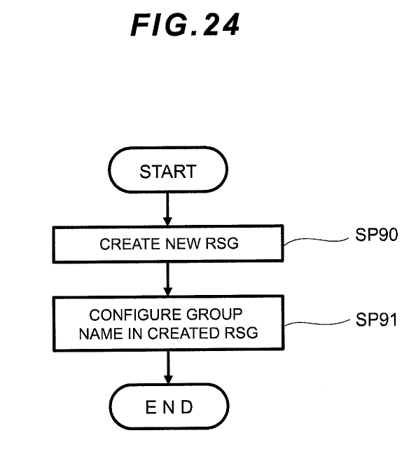

FIG. 24 shows a processing routine for resource group creation processing which is executed by the resource group management program 91 (FIG. 8) in the storage apparatus 81 which receives a resource group creation command issued by the management terminal 35 in response to the operation of the managing user with the operating privileges.

If a new resource group RSG is created, the managing user operates the management terminal 35 of the storage apparatus 81 to display a predetermined GUI screen (hereinafter called the resource group creation screen) and uses the resource group creation screen to designate the resource group name of the new resource group RSG to be created and the group GP to which the resource group RSG belongs.

Furthermore, the resource group name of the new resource group RSG designated by the managing user and the group ID of the group GP to which the resource group RSG belongs are transmitted to the resource group management program 91 as resource group creation commands together with a command to the effect that a formal new resource group RSG should be created.

Upon receipt of a resource group creation command, the resource group management program 91 starts the resource group creation processing and first creates a new resource group RSG by reserving one unused entry in the resource group ID management table 90 and storing the resource group name designated by the managing user in the resource group name field 90B for the entry (SP90).

Thereafter, the resource group management program 91 stores the group name contained in the resource group creation command in the group name field 90D of the resource group ID management table 90 (SP91) and then ends the resource group creation processing.

(2-2) Default Resource Group Division Processing

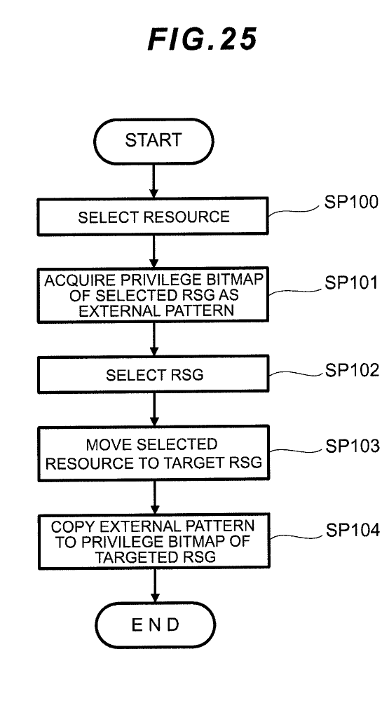

FIG. 25 shows a processing routine for default resource group division processing which is executed by the resource group management program 91 in collaboration with the group configuration function.

In the case of the computer system 80 according to this embodiment, the managing user with operating privileges uses the management terminal 35 of the storage apparatus 81 in order to be able to designate the transfer of a particular resource of a certain default resource group RSG to a particular resource group RSG, and to instruct this resource transfer. As a result of this function, moving the resource belonging to the default resource groups RSG to a newly created formal resource group RSG has the effect of dividing the default resource group RSG.

Furthermore, when the aforementioned operation by the managing user is made, the resource group management program 91 starts the default resource group division processing shown in FIG. 25 and first selects the resource designated as a migration target by the managing user (SP100).

Thereafter, the resource group management program 91 reads a privilege bitmap of the default resource group RSG to which the resource selected in step SP100 belongs as an external pattern from the default resource group ID management table 70 (FIG. 16) (SP101).

Thereafter, the resource group management program 91 acquires the resource group ID of the resource group RSG designated by the managing user as the resource migration destination from the management terminal 35 (SP102), and then migrates the migration target resources from the current destination resource group RSG to the resource group RSG for which the resource group ID was acquired in step SP102 (SP103).

Specifically, in step SP103, the resource group management program 91 executes processing to overwrite the resource group IDs stored in the resource group ID field 64C (FIG. 10) corresponding to migration target resources in the resource group configuration management table 64 (FIG. 10) with the resource group ID of the migration destination resource group RSG.

Thereafter, the resource group management program 91 copies a privilege bitmap configured for the migration source default resource group RSG, acquired as an external pattern in step SP101 to a privilege bitmap field 90C for the entry corresponding to the resource migration destination resource group RSG in the resource group ID management table 90 (FIG. 23) (SP104). As a result, the privilege which is necessary to operate the resources which belong to the default resource group RSG and which is configured for the default resource group RSG to which the resources thus far belong is transferred to the migration destination resource group RSG.

The resource group management program 91 subsequently ends the default resource group division processing.

(2-3) User Group Creation Processing

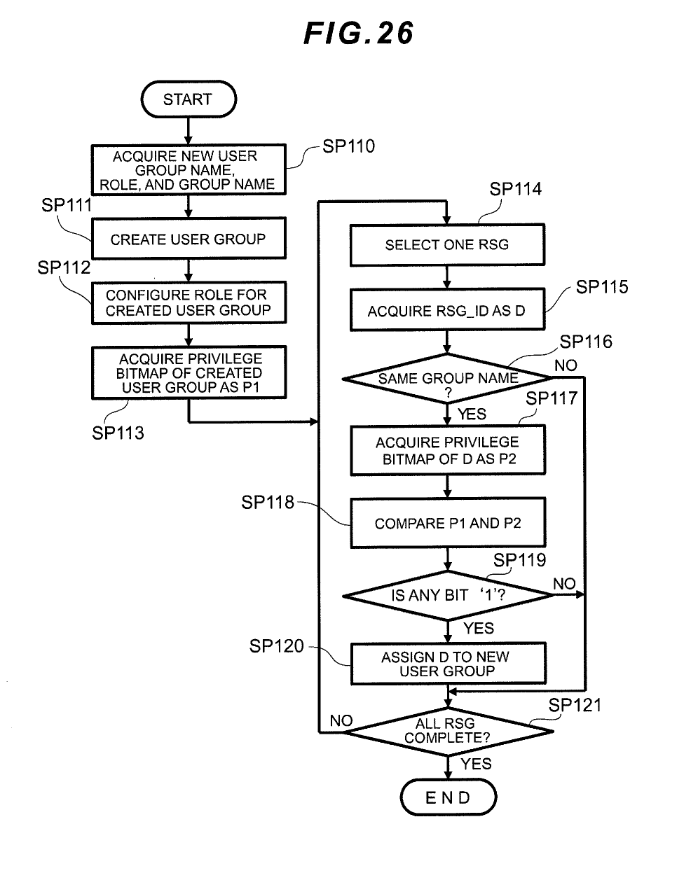

FIG. 26 shows a processing routine for user group creation processing according to the second embodiment. When initially before the storage apparatus 81 operates or after the start of operation, the management terminal 35 of the storage apparatus 81 is operated and the creation of a new user group UG is instructed, the account management program 92 (FIG. 3) according to this embodiment creates the new user group UG according to the processing routine shown in FIG. 26.

In other words, in the storage apparatus 81, the management terminal 35 is operated by a managing user with the operating privileges and the group name (user group ID) of the user group UG to be newly created, the roles which are to be assigned to the user group UG and the group name of the group (group of the resource group RSG) GP associated with the user group UG are designated, and then when an instruction to create the user group UG is input, a corresponding user group creation command is supplied from the management terminal 35 to the account management program 92.

When the user group creation command is supplied, the account management program 92 starts the user group creation processing and first acquires the group name of the new user group contained in the user group creation command and the role which is to be assigned to the user group UG (SP110).

Thereafter, the account management program 92 creates the requested new user group UG as per steps SP11 and SP12 of the user group creation processing according to the first embodiment mentioned earlier with reference to FIG. 19 (SP111), and then assigns roles to the user group (SP112).

In addition, the account management program 92 subsequently acquires the privilege bitmap for the newly created user group UG as ‘P1’ (SP113). Precisely speaking, the account management program 92 acquires the privilege bitmap for the role assigned to the user group UG in step SP112 from the role management table 67 (FIG. 13) as ‘Pr.

Thereafter, the account management program 92 selects one resource group RSG from among the resource groups RSG registered in the resource group ID management table 90 (FIG. 23) (SP114), and acquires the resource group ID of the resource group RSG as ‘D’ (SP115).

The account management program 92 subsequently reads the group name of the group GP to which the resource group RSG selected in step SP114 belongs from the resource group ID management table 90 (FIG. 23) and determines whether or not the group name is the same as the group name acquired in step SP110 (SPI 16).

The account management program 92 advances to step SP121 upon obtaining a negative result in this determination, however when an affirmative result is obtained, the account management program 92 processes steps SP117 to SP120 in the same way as steps SP16 to SP19 of the user group creation processing according to the first embodiment with reference to FIG. 19.

In addition, the account management program 92 subsequently determines whether or not execution of the same processing is complete for all the resource groups RSG which are registered in the resource group ID management table 90 and to which a resource group ID has been assigned (SP121) and returns to step SP114 when a negative result is obtained.

Furthermore, the account management program 92 subsequently repeats the processing of steps SP114 to SP121 while sequentially switching the resource group RSG selected in step SP114 to another unprocessed resource group RSG. As a result, all the resource groups RSG which can be operated according to the roles assigned to the user groups UG among the resource groups RSG belonging to the group GP designated by the managing user come to be assigned to the new user group UG.

In addition, when an affirmative result is obtained in step S121 as a result of completing the execution of the same processing for all the resource groups RSG which are already registered in the resource group ID management table 90, the account management program 92 ends the user group creation processing.

(2-4) Effect of the Embodiment

In the computer system 80 according to this embodiment, the resource groups RSG are managed after being divided into groups and since all the resource groups RSG which can be operated according to the roles assigned to the user group UG among the resource groups RSG which belong to the group GP designated for the user group UG are assigned to the user group UG, only the resource groups RSG in the range limited to the user group UG can be assigned.

Therefore, for example, if the storage apparatus 81 is shared by a plurality of organizations, the managing users of each of the organizations are able to manage and operate the resources which are assigned to their own organization.

Accordingly, according to the computer system 80 according to this embodiment, an effect enabling the security of the computer system 80 to be improved can be obtained in addition to the effect obtained by the first embodiment.

### (3) Other Embodiments

Note that although the foregoing first and second embodiments explained a case in which the present invention is applied to a storage apparatus configured as per FIG. 3, the present invention is not limited to such a case and may be widely applied to storage apparatuses with a variety of other configurations.

In addition, although, in the first and second embodiments hereinabove, a case was described with five types of grouping target resources which are grouped in resource groups RSG, namely, logic device numbers, parity groups, external volumes, ports and host groups, the present invention is not limited to such resources; other resources may also serve as grouping targets.

Furthermore, although a case was described in the second embodiment where a new resource group RSG is created by dividing a default resource group RSG, the present invention is not limited to this case; rather, new resource groups can also be created by dividing resource groups RSG other than the default resource group RSG.

Furthermore, although a case was described in the first embodiment above where, when creating a user group UG, all the default resource groups RSG which can be operated within the scope of the operating privileges assigned to the new user group UG are assigned (see FIG. 19), the present invention is not limited to this case; not only the default resource groups RSG, but also all the resource groups RSG which can be operated within the scope of the operating privileges assigned to the new user group UG, may be assigned.

### INDUSTRIAL APPLICABILITY

The present invention can be widely applied to storage apparatuses for which the multitenancy-type management system is adopted.

### REFERENCE SIGNS LIST

1, 80 Computer system

2 Host computer

3, 81 Storage apparatus

35 Management terminal

43 Microprocessor

47 Control information memory

50, 91 Resource group management program

55 Server program

56, 65 Session management table

61, 91 Resource group control program

62, 92 Account management program

63, 90 Resource group ID management table

64 Resource group configuration management table

66 Privilege bitmap management table

67 Role management table

68 User group management table

69 User account management table

70 Default resource group ID management table

71 Program product management table

RSG Resource group

UG User group.

1. A storage apparatus which is managed by a plurality of managing users, comprising:
a resource group control unit which divides management target resources into a plurality of resource groups;
an access control processing unit for executing access control processing which places the resource groups into a range of management operations by the managing users; and
an exclusive control unit which executes exclusive control processing which places the resource groups into an exclusive control range for management operations by the managing users.

2. The storage apparatus according to claim 1, comprising:
an account management unit which manages the plurality of managing users divided into one or more user groups,
wherein one or more of the resource groups and one or more operating privileges are assigned to each of the user groups, and
wherein the exclusive control unit receives requests from managing users within the scope of the resource groups and the operating privileges assigned to the user groups to which the managing users belong.

3. The storage apparatus according to claim 2,
wherein operating privileges which are required to operate the resource groups are pre-configured for each of the resource groups; and
wherein the account management unit,
creates a new user group in response to a managing user operation and configures the operating privileges designated by the managing user for the user group, and
assigns, to the new user group thus created, all the resource groups which can be operated according to the operating privileges configured for the user group.

4. The storage apparatus according to claim 3,
wherein the resource group control unit creates a new resource group by dividing the resource group and configures, for the new resource group thus created, the same operating privileges as the operating privileges required to operate the resource group, configured for the resource group which is a division source.

5. The storage apparatus according to claim 3,
wherein the resource groups are divided into groups designated by the managing users, and
wherein the account management unit,
when the resource groups are assigned to the new user group thus created,
assigns all the resource groups, which can be operated according to the operating privileges configured for the user group, among the resource groups which belong to the group which is pre-designated for the user group.

6. A control method for a storage apparatus managed by a plurality of managing users, comprising:
a first step of dividing management target resources into a plurality of resource groups;
a second step of executing access control processing unit for executing access control processing which places the resource groups into a range of management operations by the managing users, and executing exclusive control processing which places the resource groups into an exclusive control range for management operations by the managing users.

7. The control method for a storage apparatus according to claim 6,
wherein, in the first step,
the plurality of managing users are divided into one or more user groups, and one or more of the resource groups and one or more operating privileges are assigned to each of the user groups and,
wherein, in the second step,
requests are received from the managing users within the scope of the resource groups and the operating privileges assigned to the user groups to which the managing users belong.

8. The control method for a storage apparatus according to claim 7,
wherein the operating privileges are pre-configured for each of the resource groups in order to operate the resource groups, and
wherein, in the first step,
the new user group is created in response to a managing user operation and the operating privileges designated by the managing user are configured for the user group, and
all the resource groups which can be operated according to the operating privileges configured for the user group are assigned to the new user group thus created.

9. The control method for a storage apparatus according to claim 8,
wherein, in the first step,
the resource group is divided to create new resource groups, and the same operating privileges as the operating privileges required to operate the resource group, configured for the resource group which is a division source, are configured for the new resource group thus created.

10. The control method for a storage apparatus according to claim 8,
wherein the resource groups are divided into groups designated by the managing users and,
wherein, in the first step,
when the resource groups are assigned to the new user group thus created,
all the resource groups, which can be operated according to the operating privileges configured for the user group, among the resource groups which belong to the group which is pre-designated for the user group, are assigned.
